(19) United States
(12) Patent Application Publication
(10) Pub. No.: US 2025/0016818 A1
(43) Pub. Date: Jan. 9, 2025

(54) SIDELINK AND UPLINK TRANSMISSIONS AND RECEPTIONS

(71) Applicant: Samsung Electronics Co., Ltd., Suwon-si (KR)

(72) Inventors: Carmela Cozzo, San Diego, CA (US); Emad Nader Farag, Flanders, NJ (US); Hongbo Si, Allen, TX (US)

(21) Appl. No.: 18/752,134

(22) Filed: Jun. 24, 2024

Related U.S. Application Data
(60) Provisional application No. 63/525,569, filed on Jul. 7, 2023.
(60) Provisional application No. 63/563,131, filed on Mar. 8, 2024.

(51) Int. Cl. H04W 72/563; H04W 72/40

(52) U.S. Cl. CPC H04W 72/563; H04W 72/40

(57) ABSTRACT

Apparatuses and methods for sidelink and uplink transmissions and receptions. A method performed by a user equipment (UE) includes receiving first information for sidelink operation on multiple sidelink carriers. The first information includes priority values associated with the multiple sidelink carriers. The method includes determining a first number of sidelink carriers from the multiple sidelink carriers based on the priority values, first simultaneous transmissions or receptions on the first number of sidelink carriers based on the first information, a first sidelink carrier from the multiple sidelink carriers, wherein the first sidelink carrier is not in the first number of sidelink carriers, and whether to postpone or drop a first transmission or reception on the first sidelink carrier based on a physical channel associated with the first transmission or reception. The method further includes transmitting or receiving the first simultaneous transmissions or receptions on the first number of sidelink carriers.

### CROSS-REFERENCE TO RELATED AND CLAIM OF PRIORITY

The present application claims priority under 35 U.S.C. § 119(e) to U.S. Provisional Patent Application No. 63/525,569 filed on Jul. 7, 2023, and U.S. Provisional Patent Application No. 63/563,131 filed on Mar. 8, 2024, which are hereby incorporated by reference in their entirety.

### TECHNICAL FIELD

The present disclosure relates generally to wireless communication systems and, more specifically, the present disclosure is related to apparatus and method for sidelink and uplink transmissions and receptions.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to sidelink and uplink transmissions and receptions.

In one embodiment, a user equipment (UE) in a wireless communication system is provided. The UE includes a transceiver configured to receive first information for sidelink operation on multiple sidelink carriers. The first information includes priority values associated with the multiple sidelink carriers. The UE further includes a processor operably coupled to the transceiver. The processor is configured to determine a first number of sidelink carriers from the multiple sidelink carriers based on the priority values, first simultaneous transmissions or receptions on the first number of sidelink carriers based on the first information, a first sidelink carrier from the multiple sidelink carriers, wherein the first sidelink carrier is not in the first number of sidelink carriers, and whether to postpone or drop a first transmission or reception on the first sidelink carrier based on a physical channel associated with the first transmission or reception. The transceiver is further configured to transmit or receive the first simultaneous transmissions or receptions on the first number of sidelink carriers.

In another embodiment, a method performed by a UE in a wireless communication system is provided. The method includes receiving first information for sidelink operation on multiple sidelink carriers. The first information includes priority values associated with the multiple sidelink carriers. The method includes determining a first number of sidelink carriers from the multiple sidelink carriers based on the priority values, first simultaneous transmissions or receptions on the first number of sidelink carriers based on the first information, a first sidelink carrier from the multiple sidelink carriers, wherein the first sidelink carrier is not in the first number of sidelink carriers, and whether to postpone or drop a first transmission or reception on the first sidelink carrier based on a physical channel associated with the first transmission or reception. The method further includes transmitting or receiving the first simultaneous transmissions or receptions on the first number of sidelink carriers.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5 illustrates an example of a transmitter structure for beamforming according to embodiments of the present disclosure;

FIG. 6 illustrates a flowchart of an example process for a layer-2 link establishment for unicast mode of vehicle to everything (V2X) communication over protocol layer convergence for 5G new radio (PC5) reference point according to embodiments of the present disclosure;

FIG. 7 illustrates a flowchart of an example UE procedure for transmitting a physical sidelink shared channel (PSSCH)/physical sidelink control channel (PSCCH) on a sidelink carrier according to embodiments of the present disclosure;

FIG. 8 illustrates a flowchart of an example UE procedure for transmitting a PSSCH/PSCCH on a sidelink carrier according to embodiments of the present disclosure;

FIG. 9 illustrates a flowchart of an example UE procedure for transmitting/receiving on multiple sidelink carriers according to embodiments of the present disclosure;

FIG. 10 illustrates a flowchart of an example UE procedure for sidelink operation on multiple carriers to postpone a physical sidelink feedback channel (PSFCH) reception according to embodiments of the present disclosure;

FIG. 11 illustrates a flowchart of an example UE procedure for sidelink operation on multiple carriers according to embodiments of the present disclosure; and

FIG. 12 illustrates a flowchart of an example UE procedure for prioritizing between uplink and sidelink transmissions/receptions according to embodiments of the present disclosure.

### DETAILED DESCRIPTION

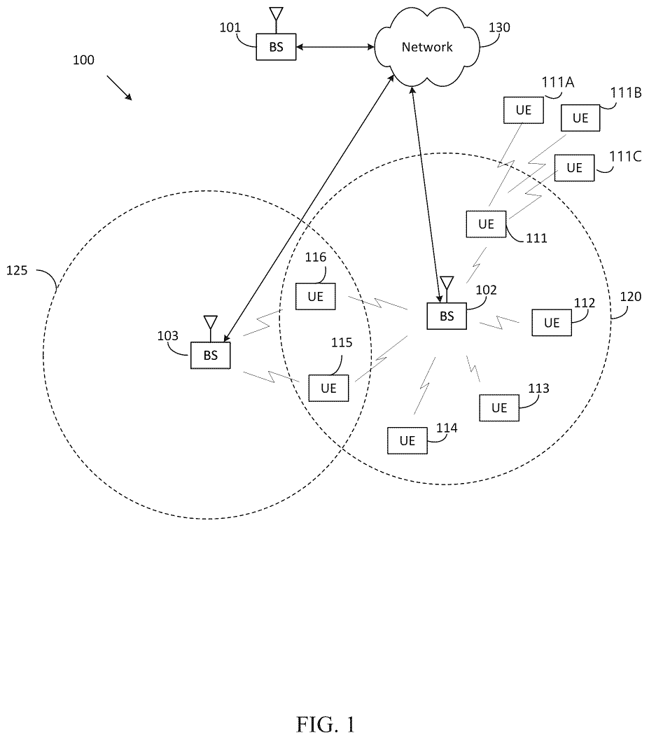

FIGS. 1-12, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP TS 38.211 v17.4.0, “NR; Physical channels and modulation;” [2] 3GPP TS 38.212 v17.4.0, “NR; Multiplexing and Channel coding;” [3] 3GPP TS 38.213 v17.4.0, “NR; Physical Layer Procedures for Control;” [4] 3GPP TS 38.214 v17.4.0, “NR; Physical Layer Procedures for Data;” [5] 3GPP TS 38.321 v17.3.0, “NR; Medium Access Control (MAC) protocol specification;” [6] 3GPP TS 38.331 v17.3.0, “NR; Radio Resource Control (RRC) Protocol Specification;” [7] 3GPP TS 36.213 v17.4.0, “Evolved Universal Terrestrial Radio Access (E-UTRA); Physical layer procedures;” and [8] RP-213678, “WID on NR sidelink evolution”, OPPO, LG Electronics, e-meeting December 2021.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.1la/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing sidelink and uplink transmissions and receptions. In certain embodiments, one or more of the BSs 101-103 include circuitry, programing, or a combination thereof for supporting sidelink and uplink transmissions and receptions.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to common fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

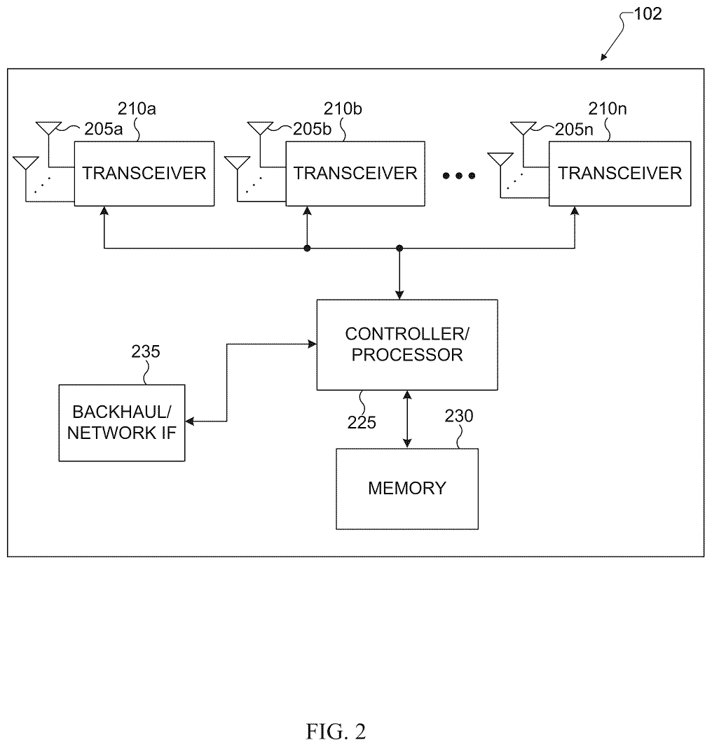

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting sidelink and uplink transmissions and receptions. Any of a wide variety of other functions could be supported in the gNB 102 by the controller/processor 225.

The controller/processor 225 is also capable of executing programs and other processes resident in the memory 230, such as supporting sidelink and uplink transmissions and receptions. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

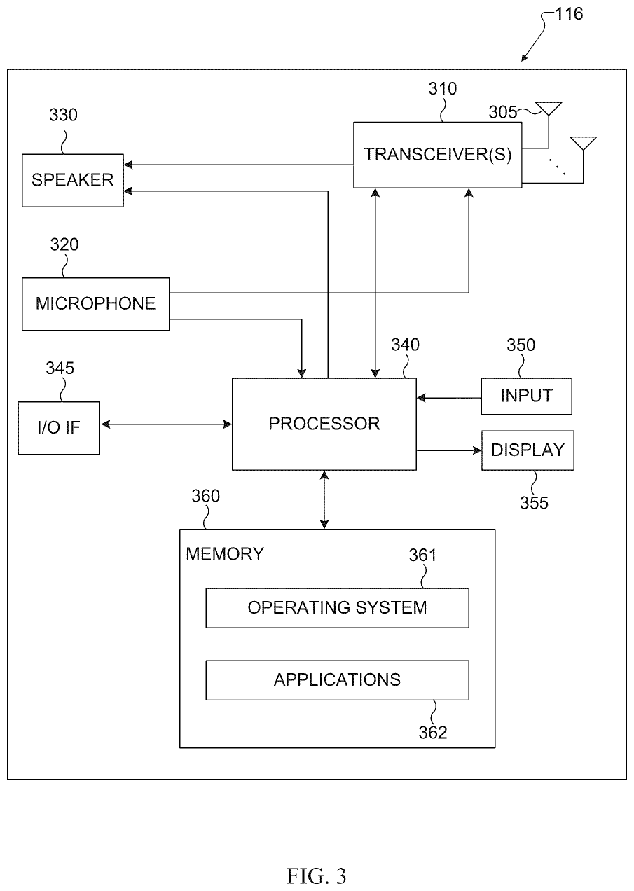

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL and/or SL channels and/or signals and the transmission of UL and/or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for supporting or utilizing sidelink and uplink transmissions and receptions as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

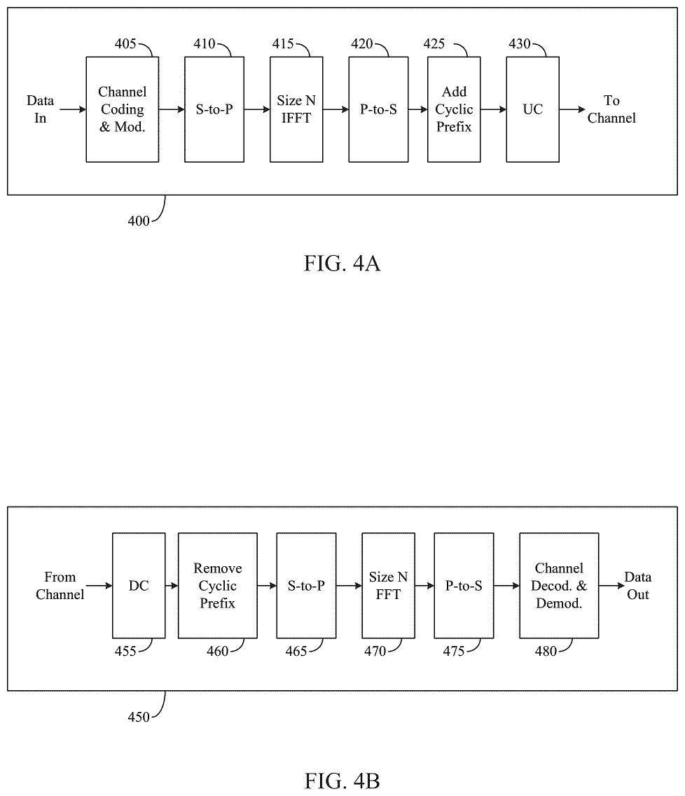

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. It may also be understood that the receive path 450 can be implemented in a first UE and that the transmit path 400 can be implemented in a second UE to support SL communications. In some embodiments, the receive path 450 is configured to support sidelink and uplink transmissions and receptions as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

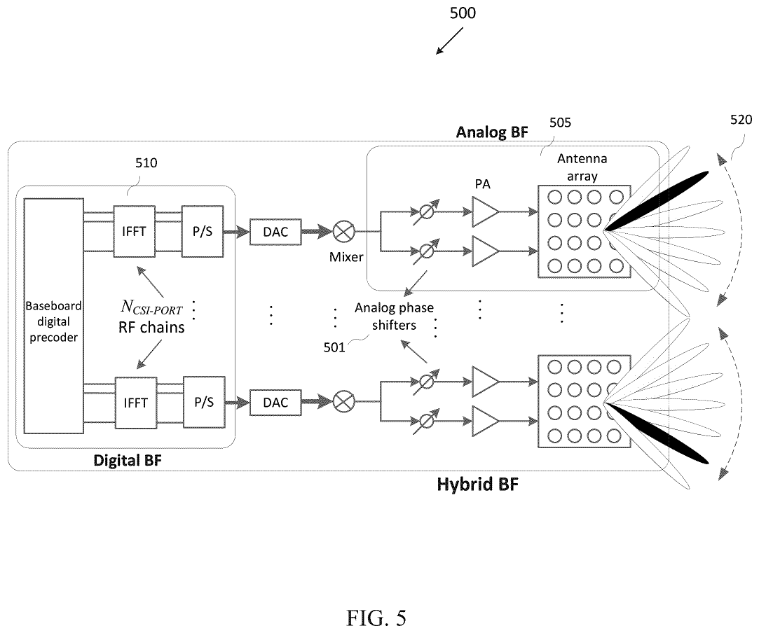

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

This disclosure considers prioritization of transmissions and receptions when a transmitting SL UE and/or a receiving SL UE is configured for operation with multiple carriers.

When a transmitting SL UE and a receiving SL UE is configured for operation with carrier aggregation with multiple carriers for SL (e.g., PC5) interface, the transmitting SL UE transmits on a first number of carriers and receives on a second number of carriers, and the first and second number of carriers can be the same or different, and can be 1 or larger. When the UE (e.g., the UE 111A) uses more than one carrier for SL transmission or reception, the transmission or reception on one carrier may overlap in time with the transmission or reception on another carrier, and the overlap may occur for a portion of the transmission or reception, or for the whole duration of the transmission or reception. Subject to a UE capability, the UE may transmit and receive simultaneously on different carriers, or the UE may transmit simultaneously on different carriers, or the UE may receive simultaneously on different carriers. Thus, embodiments of the present disclosure recognize that there is a need to determine the channels/signals to transmit and/or receive simultaneously on the different carriers for the sidelink (e.g., NR-PC5) interface.

When a transmitting SL UE and/or a receiving SL UE is configured for operation with multiple carriers, the transmitting SL UE and/or the receiving SL UE can also transmit and/or receive using one or multiple carriers to/from a gNB. Subject to a UE capability, the UE may transmit and receive simultaneously on different carriers, or the UE may transmit simultaneously on different carriers, or the UE may receive simultaneously on different carriers, and the different carriers can be for the sidelink (e.g., NR-PC5) interface and the NR-Uu interface. Thus, there is a need to determine the channels/signals to transmit and/or receive simultaneously on the different carriers for the sidelink (e.g., NR-PC5) interface and the NR-Uu interface when the UE is configured to operate with multiple carriers on the sidelink.

When there is an overlap between transmissions over multiple carriers over a time period, for example, between a first transmission on a first carrier and a second transmission on a second carrier, and first and second carriers are configured for the sidelink, the UE may transmit on both carriers simultaneously using a first power and a second power, respectively, when the sum of the first power and the second power does not exceed the total UE transmission power over the time period, or the UE may prioritize the transmission over one of the carriers and not transmit on the other carrier. When there is an overlap between transmissions over multiple carriers configured for the sidelink and for the UL over a time period, for example, two carriers are configured for the sidelink and two carriers are configured for UL, the UE may transmit on the carriers with overlapping transmissions if the sum of the transmit powers of the channels/signals over the carriers does not exceed the total UE transmission power over the time period, or may transmit on some of the carriers by prioritizing the channels/signals to transmit based on prioritization rules for the channels/signals and the sidelink/uplink. Thus, there is a need to determine the channels/signals to transmit on one or more carrier based on the required powers for the transmission of the channels/signals on each carrier and the maximum UE transmission power, and on priorities for transmission of channels/signals on the sidelink and on the UL.

A UE operating with SL CA can transmit in each carrier a physical SL feedback channel (PSFCH) to provide hybrid automatic repeat request acknowledgement (HARQ-ACK) information and/or conflict information corresponding to a reception on the same carrier, and can determine the power of the PFSCH in each carrier based on a DL open loop power control and/or a SL open loop power control for the same carrier. When the UE is configured for operation with carrier aggregation with multiple carriers, and there is an overlap between transmissions of PFSCHs on corresponding carriers, the UE may prioritize transmission of the PFSCH(s) on one or more carriers based on priority rules and power of the PFSCH transmission, subject to a UE capability of simultaneous transmissions and/or to a UE capability of transmitting and receiving simultaneously. Thus, there is a need to determine PFSCH transmission when the UE is configured for operation with multiple carriers over the sidelink.

The disclosure relates to transmissions and receptions for a transmitting SL UE and a receiving SL UE operating with carrier aggregation. The disclosure relates to determining channels/signals to transmit and/or receive when the UE is configured for operation with multiple carriers for the sidelink. The disclosure also relates to determining channels/signals to transmit and/or receive when the UE is configured for operation with multiple carriers for the sidelink and for the uplink. The disclosure further relates to determining prioritizations for sidelink and uplink transmissions/receptions.

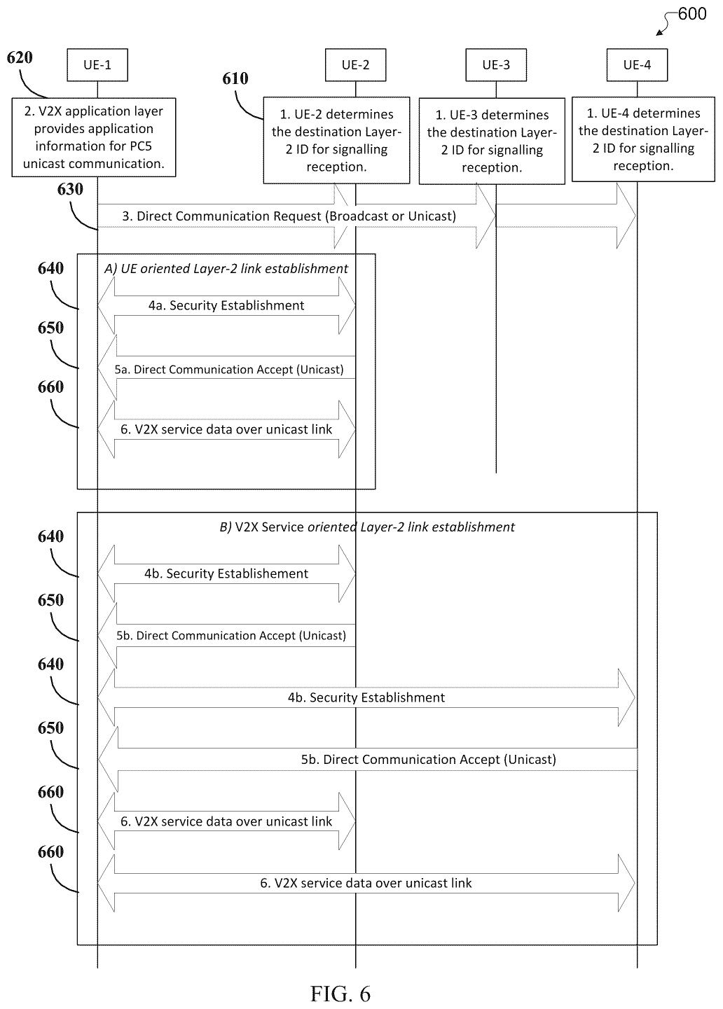

FIG. 6 illustrates a flowchart of an example process 600 for a layer-2 link establishment for unicast mode of V2X communication over PC5 reference point according to embodiments of the present disclosure. For example, process 600 can be performed by multiple of the UEs 111-116 of FIG. 1 to perform SL communications. This example is for illustration only and other embodiments can be used without departing from the scope of the present disclosure.

Process 600 begins in step 610, the UE(s) determine the destination Layer-2 ID for signaling reception of PC5 unicast link establishment. This is determined as specified in clause 5.6.1.4 of TS 23.387. The destination Layer-2 ID is configured with the UE(s) as specified in clause 5.1.2.1 of TS 23.387. In step 620, the V2X application layer in UE-1 provides application information for PC5 unicast communicating. In step 630, UE-1 sends a Direct Communication Request (DCR) to initiate the unicast layer-2 link establishment procedure and sends the DCR message via PC5 broadcast or unicast using the source Layer-2 ID and destination Layer-2 ID. In step 640, the target UE, or the UEs that are interested in using the announced V2X service type(s) over a PC5 unicast link with UE-1, responds which establishes the security with UE-1. In step 650, the target UE(s) that has successfully established security with UE-1 sends a direct communication accept message to UE-1. In step 660, V2X service data is transmitted over the established unicast link.

With reference to FIG. 6 (FIG. 6.3.3.1-1 of TS 23.387) the Layer-2 link establishment procedure for unicast mode of V2X communication over PC5 reference point is shown.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SL control information (SCI), physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (negative acknowledgment (NACK) value) transport block receptions in respective PSSCHs, and physical SL Broadcast channel (PSBCH) conveying system information to assist in SL synchronization. SL signals include demodulation reference signals (DM-RS) that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. SCI can include two parts/stages corresponding to two respective SCI formats where, for example, the first SCI format is multiplexed on a PSCCH, and the second SCI format is multiplexed along with SL data on a PSSCH that is transmitted in physical resources indicated by the first SCI format.

A SL channel can operate in different cast modes. In a unicast mode, a PSCCH/PSSCH conveys SL information from one UE to one other UE. In a groupcast mode, a PSCCH/PSSCH conveys SL information from one UE to a group of UEs within a (pre-)configured set. In a broadcast mode, a PSCCH/PSSCH conveys SL information from one UE to surrounding UEs. In NR release 16, there are two resource allocation modes for a PSCCH/PSSCH transmission. In resource allocation mode 1, a gNB schedules a UE on the SL and conveys scheduling information to the UE transmitting on the SL through a downlink control information (DCI) format (e.g., DCI Format 3_0) transmitted from the gNB (e.g., the gNB 102) on the DL. In resource allocation mode 2, a UE schedules a SL transmission. SL transmissions can operate within network coverage where each UE is within the communication range of a gNB, outside network coverage where UEs have no communication with any gNB, or with partial network coverage, where some UEs are within the communication range of a gNB.

In case of groupcast PSCCH/PSSCH transmission, a network can configure a UE one of two options for reporting of HARQ-ACK information by the UE:
HARQ-ACK reporting option (1): A UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB.
HARQ-ACK reporting option (2): A UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option (1), when a UE that transmitted the PSSCH detects a NACK in a PSFCH reception, the UE can transmit another PSSCH with the TB (retransmission of the TB). In HARQ-ACK reporting option (2) when a UE that transmitted the PSSCH does not detect an ACK in a PSFCH reception, such as when the UE detects a NACK or does not detect a PSFCH reception, the UE can transmit another PSSCH with the TB.

A sidelink resource pool includes a set/pool of slots and a set/pool of RBs used for sidelink transmission and sidelink reception. A set of slots which belong to a sidelink resource pool can be denoted by

$$\{ {t}_{0}^{′ SL} , {t}_{1}^{′ S L} , {t}_{2}^{′ SL} , … , {t}_{{T}_{MAX}^{′} - 1}^{′ SL} \}$$

and can be configured, for example, at least using a bitmap. Where, T′_{MAX} is the number of SL slots in a resource pool within 1024 frames. Within each slot t′_{y}^{SL} of a sidelink resource pool, there are N_{subCH} contiguous sub-channels in the frequency domain for sidelink transmission, where N_{subCH} is provided by a higher-layer parameter. Subchannel m, where m is between 0 and N_{subCH} −1, is given by a set of n_{subCHsize} contiguous PRBs, given by n_{PRB}=n_{subCHstart}+m·n_{subCHsize}+j, where j=0, 1, . . . , n_{subCHsize}−1, n_{subCHstart} and n_{subCHsize} are provided by higher layer parameters.

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL} where T_{proc,1}^{SL} is a PSSCH processing time, for example, as defined in TS 38.214 [4] Table 8.1.4-2. T₂ is determined by the UE such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is a configured by higher layers and depends on the priority of the SL transmission.

The slots of a SL resource pool are determined as follows:
1. Let set of slots that may belong to a resource be denoted by {t₀^{SL}, t₁^{SL}, t₂^{SL}, . . . , t_{T}_{_{MAX}}₋₁^{SL}}, where 0≤tᵢ^{SL}<10240×2^{μ}, and 0≤i<Tₘₐₓ. μ is the sub-carrier spacing configuration. μ=0 for a 15 kHz sub-carrier spacing. μ=1 for a 30 kHz sub-carrier spacing. μ=2 for a 60 kHz sub-carrier spacing. μ=8 for a 120 kHz sub-carrier spacing. The slot index is relative to slot #0 of system frame number (SFN) #0 of the serving cell, or downlink frame number (DFN) #0. The set of slots includes slots except:
   a. N_{S-SSB} slots that are configured for SL synchronization signal/physical broadcast channel (SS/PBCH) Block (S-SSB).
   b. N_{nonSL} slots where at least one SL symbol is not semi-statically configured as UL symbol by higher layer parameter tdd-UL-DL-ConfigurationCommon or sl-TDD-Configuration. In a SL slot, OFDM symbols Y-th, (Y+1)-th, . . . , (Y+X−1)-th are SL symbols, where Y is determined by the higher layer parameter sl-StartSymbol and X is determined by higher layer parameter sl-LengthSymbols.
   c. N_{reserved} reserved slots. Reserved slots are determined such that the slots in the set {t₀^{SL}, t₁^{SL}, t₂^{SL}, . . . , t_{T}_{_{MAX}}₋₁^{SL}} is a multiple of the bitmap length (L_{bitmap}), where the bitmap (b₀, b₁, . . . , b_{L}_{_{bitmap}}₋₁) is configured by higher layers. The reserved slots are determined as follows:
      i. Let {l₀, l₁, . . . , l₂_{^{μ}}_{×10240-N}_{_{S-SSB}}_{-N}_{_{nonSL}}₋₁} be the set of slots in range 0 . . . 2^{μ}×10240-1, excluding S-SSB slots and non-SL slots. The slots are arranged in ascending order of the slot index.
      ii. The number of reserved slots is given by: N_{reserved}=(2^{μ}×10240−N_{S-SSB}−N_{nonSL}) mod L_{bitmap}.
      iii. The reserved slots lᵣ are given by:

$$r = ⌊ \frac{m \cdot ( {2}^{μ} \times 10240 - {N}_{S - SSB} - {N}_{n o n S L} )}{{N}_{r e s e r v e d}} ⌋ ,$$

where, m=0, 1, . . . , N_{reserved}−1.
   iv. Tₘₐₓ is given by: Tₘₐₓ=2^{μ}×10240−N_{S-SSB}−N_{nonSL}−N_{reserved}.
2. The slots are arranged in ascending order of slot index.
3. The set of slots belonging to the SL resource pool, {t′₀^{SL}, t′₁^{SL}, t′₂^{SL}, . . . , t′_{T′}_{_{MAX}}₋₁^{SL}}, are determined as follows:
   a. Each resource pool has a corresponding bitmap (b₀, b₁, . . . , b_{L}_{_{bitmap}}₋₁) of length L_{bitmap}.
   b. A slot tₖSL belongs to the SL resource pool if b_{k mod L}_{_{bitmap}}=1.
   c. The remaining slots are indexed successively staring from 0, 1, . . . T′_{MAX}−1.
      Where, T′_{MAX} is the number of remaining slots in the set.

Slots can be numbered (indexed) as physical slots or logical slots, wherein physical slots include slots numbered sequential, while logical slots include slots that can be allocated to sidelink resource pool as described herein numbered sequentially. The conversion from a physical duration, Pᵣₛᵥₚ, in milli-second to logical slots, P′ᵣₛᵥₚ, is given by

$${P}_{r s v p}^{′} = ⌈ \frac{{T}_{max}^{′}}{10240 ms} \times {P}_{r s v p} ⌉$$

(see section 8.1.7 of TS 38.214 [4]).

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH} −1 in slot t_{y}^{SL}. T₁ is determined by the UE such that, 0≤T₁≤T_{proc,1}^{SL}, where T_{proc,1}^{SL} is a PSSCH processing time for example as defined in 3GPP standard specification, TS 38.214 [4] Table 8.1.4-2. T₂ is determined by the UE such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is configured by higher layers and depends on the priority of the SL transmission.

The resource (re-)selection is a two-step procedure:
The first step (e.g., performed in the physical layer) is to identify the candidate resources within a resource selection window. Candidate resources are resources that belong to a resource pool, but exclude resources (e.g., resource exclusion) that were previously reserved, or reserved by other UEs. The resources excluded are based on SCIs decoded in a sensing window and for which the UE measures a SL reference signal received power (RSRP) that exceeds a threshold. The threshold depends on the priority indicated in a SCI format and on the priority of the SL transmission. Therefore, sensing within a sensing window involves decoding the first stage SCI, and measuring the corresponding SL RSRP, wherein the SL RSRP can be based on PSCCH demodulation reference signal (DMRS) or PSSCH DMRS. Sensing is performed over slots where the UE doesn't transmit SL. The resources excluded are based on reserved transmissions or semi-persistent transmissions that can collide with the excluded resources or any of reserved or semi-persistent transmissions. The identified candidate resources after resource exclusion are provided to higher layers.
The second step (e.g., performed in the higher layers) is to select or re-select a resource from the identified candidate resources for PSSCH/PSCCH transmission.

During the first step of the resource (re-)selection procedure, a UE can monitor slots in a sensing window [n−T₀, n−T_{proc,0}^{SL}), where the UE (e.g., the UE 111A) monitors slots belonging to a corresponding sidelink resource pool that are not used for the UE's own transmission. For example, T_{proc,0}^{SL} is the sensing processing latency time, for example as defined in 3GPP standard specification, TS 38.214 [4] Table 8.1.4-1. To determine a candidate single-slot resource set to report to higher layers, a UE excludes (e.g., resource exclusion) from the set of available single-slot resources for SL transmission within a resource pool and within a resource selection window, the following:
1. Single slot resource R_{x,y} such that for any slot t′ₘ^{SL} not monitored within the sensing window with a hypothetical received SCI Format 1-0, with a “Resource reservation period” set to any periodicity value allowed by a higher layer parameter reservationPeriodAilowed, and indicating sub-channels of the resource pool in this slot, satisfies condition 2.2. herein.
2. Single slot resource R_{x,y} such that for any received SCI within the sensing window:
   i. The associated L1-RSRP measurement is above a (pre-)configured SL-RSRP threshold, where the SL-RSRP threshold depends on the priority indicated in the received SCI and that of the SL transmission for which resources are being selected.
   ii. (Condition 2.2) The received SCI in slot t′ₘ^{SL}, or if “Resource reservation field” is present in the received SCI the same SCI is assumed to be received in slot

$${t}_{m + q \times {P}_{rsvp \_ Rx}^{′}}^{′ S L} ,$$

indicates a set of resource blocks that overlaps

$${R}_{x , y + j \times {P}_{rsvp \_ Tx}^{′}}$$

Where,
   q=1, 2, . . . , Q, where,
   If P_{rsvp_RX}≤T_{scal} and

$${n}^{′} - m < {P}_{rsvp \_ Rx}^{′} \to Q = ⌈ \frac{{T}_{s c a l}}{{P}_{rsvp \_ RX}} ⌉ .$$

T_{scal} is T₂ in units of milli-seconds.
Else, Q=1.
If n belongs to

$$( {t}_{0}^{′ S L} , {t}_{1}^{′ S L} , … , {t}_{{T}_{max - 1}^{′}}^{′ S L} ) ,$$

n′=n, else n′ is the first slot after slot n belonging to set

$$( {t}_{0}^{′ S L} , {t}_{1}^{′ S L} , … , {t}_{{T}_{max - 1}^{′}}^{′ S L} ) .$$

j=0, 1, . . . , Cᵣₑₛₑₗ−1.
P_{rsvp_RX} is the indicated resource reservation period in the received SCI in physical slots, and P′_{rsvp_Rx} is that value converted to logical slots.
P′_{rsvp_Tx} is the resource reservation period of the SL transmissions for which resources are being reserved in logical slots.
3. If the candidate resources are less than a (pre-)configured percentage given by higher layer parameter sl_TxPrecentageList(prio_{TX}) that depends on the priority of the SL transmission prio_{TX}, such as 20%, of the total available resources within the resource selection window, the (pre-)configured SL-RSRP thresholds are increased by a predetermined amount, such as 3 dB.

NR sidelink introduced two new procedures for mode 2 resource allocation; re-evaluation and pre-emption.

Re-evaluation check occurs when a UE checks the availability of pre-selected SL resources before the resources are first signaled in an SCI Format, and if needed re-selects new SL resources. For a pre-selected resource to be first-time signaled in slot m, the UE performs a re-evaluation check at least in slot m−T₃. The re-evaluation check includes:
Performing the first step of the SL resource selection procedure as defined in the 3GPP specifications [i.e., TS 38.214 [4] clause 8.1.4], which involves identifying a candidate (available) sidelink resource set in a resource selection window as previously described.
If the pre-selected resource is available in the candidate sidelink resource set, the resource is used/signaled for sidelink transmission.
Else, the pre-selected resource is not available in the candidate sidelink resource set, a new sidelink resource is re-selected from the candidate sidelink resource set.

Pre-emption check occurs when a UE checks the availability of pre-selected SL resources that have been previously signaled and reserved in an SCI Format, and if needed re-selects new SL resources. For a pre-selected and reserved resource to be signaled in slot m, the UE (e.g., the UE 111A) performs a pre-emption check at least in slot m−T₃. When pre-emption check is enabled by higher layers, pre-emption check includes:
Performing the first step of the SL resource selection procedure as defined in the 3GPP specifications [i.e., TS 38.214 [4] clause 8.1.4], which involves identifying candidate (available) sidelink resource set in a resource selection window as previously described.
If the pre-selected and reserved resource is available in the candidate sidelink resource set, the resource is used/signaled for sidelink transmission.
Else, the pre-selected and reserved resource is NOT available in the candidate sidelink resource set. The resource is excluded from the candidate resource set due to an SCI, associated with a priority value P_{RX}, having an RSRP exceeding a threshold. Let the priority value of the sidelink resource being checked for pre-emption be P_{TX}.
   If the priority value P_{RX} is less than a higher-layer configured threshold and the priority value P_{RX} is less than the priority value P_{TX}. The pre-selected and reserved sidelink resource is pre-empted. A new sidelink resource is re-selected from the candidate sidelink resource set. Note that, a lower priority value indicates traffic of higher priority.
   Else, the resource is used/signaled for sidelink transmission.

In one example, a UE determines a power, P_{S-SSB}(i), in dBm, for an S-SS/PSBCH block (S-SSB) transmission occasion in slot i on an active SL BWP b of a carrier f, as:

$${P}_{S - SSB} ( i ) = min ( {P}_{C M A X} , {P}_{O , S - SSB} + 10 {log}_{10} ( {2}^{μ} \cdot {M}_{R B}^{S - SSB} ) + {α}_{S - SSB} \cdot PL )$$

where,
P_{CMAX} is the configured maximum output power of the UE [TS 38.101].
P_{O,S-SSB} is the P0 value for DL pathloss (PL) based power control for PSBCH. If dl-P0-PSBCH-r17 is configured and supported by the UE it is used for P_{O,S-SSB}, else if dl-P0-PSBCH-r16 is configured it is used for P_{O,S-SSB}, else DL pathloss based power control for PSBCH is disabled, i.e., P_{S-SSB}(i)=P_{CMAX}.
   dl-P0-PSBCH-r16 has a range of −16 . . . 15.
   dl-P0-PSBCH-r17 has a range of −202 . . . 24.
μ is the sub-carrier spacing configuration as previously described.
M_{RB}^{S-SSB} is the number of resource blocks for S-SS/PSBCH block transmission. M_{RB}^{S-SSB}=11.
α_{S-SSB} is the alpha value for DL pathloss based power control for PSBCH. This is provided by higher layer parameter dl-Alpha-PSBCH-r16 and is 1 if that parameter is not configured. dl-Alpha-PSBCH-r16 is a value from the set {0, 0.4, 0.5,0.6,0.7,0.8,0.9,1}.
PL is the pathloss, which is given by PL=PL_{b,f,c}(q_{d}) when the active SL BWP is on serving cell c. The RS resource q_{d} for determining the pathloss is given by:
   When the UE is configured to monitor physical downlink control channel (PDCCH) for detection of DCI Format 0_0 in serving cell c: RS resource used for determining the power of a physical uplink shared channel (PUSCH) transmission scheduled by DCI Format 0_0 in serving cell c.
   When the UE is not configured to monitor PDCCH for detection of DCI Format 0_0 in serving cell c: RS resource corresponding to SS/PBCH block used by the UE to obtain the master information block (MIB).

In one example, a UE determines a power, P_{PSSCH}(i), in dBm, for a PSSCH transmission occasion i of a resource pool, on an active SL BWP b of a carrier f, and in symbols where PSCCH is not transmitted as:

$${P}_{PSSCH} ( i ) = min ( {P}_{CMAX ,} {P}_{MAX , CBR} , min ( {P}_{P S S C H , D} ( i ) , {P}_{P S S C H , S L} ( i ) ) )$$

where,
P_{CMAX} is the configured maximum output power of the UE [TS 38.101].
P_{MAX,CBR} is determined based on the priority level and a CBR range for a CBR measured in slot i−N. Where, N is the congestion control processing time [TS 38.214 [4]].
P_{PSSCH,D}(i) is the component for DL based power control for PSSCH. Which is given by:
   If dl-P0-PSSCH-PSCCH is provided: P_{PSSCH,D}(i)=P_{O,D}+10 log₁₀ (2^{μ}·M_{RB}^{PSSCH}(i))+α_{D}·PL_{D}.
   If dl-P0-PSSCH-PSCCH is not provided: P_{PSSCH,D}(i)=min(P_{CMAX}, P_{MAX,CBR}).
   P_{O,D} is the P0 value for DL pathloss based power control for PSSCH/PSCCH. If dl-P0-PSSCH-PSCCH-r17 is configured and supported by the UE it is used for P_{O,D}, else if dl-P0-PSSCH-PSCCH-r16 is configured it is used for P_{O,D}, else DL pathloss based power control for PSSCH/PSCCH is disabled.
      dl-P0-PSSCH-PSCCH-r16 has a range of −16 . . . 15.
      dl-P0-PSSCH-PSCCH-r17 has a range of −202 . . . 24.
   μ is the sub-carrier spacing configuration as previously described.
   M_{RB}^{PSSCH}(i) is the number of resource blocks for PSSCH transmission occasion i.
   α_{D} is the alpha value for DL pathloss based power control for PSSCH/PSCCH. This is provided by higher layer parameter dl-Alpha-PSSCH-PSCCH-r16, and is 1 if that parameter is not configured. dl-Alpha-PSSCH-PSCCH-r16 is a value from the set {0, 0.4, 0.5,0.6,0.7,0.8,0.9,1}.
   PL_{D} is the DL pathloss, which is given by PL_{D}=PL_{b,f,c}(q_{d}) when the active SL BWP is on serving cell c. The RS resource q_{d} for determining the pathloss is given by:
      When the UE is configured to monitor PDCCH for detection of DCI Format 0_0 in serving cell c: RS resource used for determining the power of a PUSCH transmission scheduled by DCI Format 0_0 in serving cell c.
      When the UE is not configured to monitor PDCCH for detection of DCI Format 0_0 in serving cell c: RS resource corresponding to SS/PBCH block used by the UE to obtain the MIB.
P_{PSSCH,SL}(i) is the component for SL based power control for PSSCH. Which is given by:
   If sl-P0-PSSCH-PSCCH is provided: P_{PSSCH,SL}(i)=P_{O,SL}+10 log₁₀ (2^{μ}·M_{RB}^{PSSCH}(i))+α_{SL}·PL_{SL}.
   If sl-P0-PSSCH-PSCCH is not provided: P_{PSSCH,SL}(i)=min(P_{CMAX}, P_{PSSCH,D}(i))
   P_{O,SL} is the P0 value for SL pathloss based power control for PSSCH/PSCCH. If sl-P0-PSSCH-PSCCH-r17 is configured and supported by the UE it is used for P_{O,SL}, else if sl-P0-PBSCH-r16 is configured it is used for P_{O,SL}, else SL pathloss based power control for PSSCH/PSCCH is disabled.
      sl-P0-PSSCH-PSCCH-r16 has a range of −16 . . . 15.
      sl-P0-PSSCH-PSCCH-r17 has a range of −202 . . . 24.
   μ is the sub-carrier spacing configuration as previously described.
   M_{RB}^{PSSCH}(i) is the number of resource blocks for PSSCH transmission occasion i.
   α_{SL} is the alpha value for SL pathloss based power control for PSSCH/PSCCH. This is provided by higher layer parameter sl-Alpha-PSSCH-PSCCH-r16 and is 1 if that parameter is not configured. sl-Alpha-PSSCH-PSCCH-r16 is a value from the set {0, 0.4, 0.5,0.6,0.7,0.8,0.9,1}.
   PL_{SL} is the SL pathloss, which is given by PL_{SL}=referenceSignalPower−higher layer filtered RSRP:
      referenceSignalPower is obtained by summing the PSSCH transmit power per RE over antenna ports and higher layer filtered across PSSCH transmission occasions using filter configuration provided by sl-FilterCoefficient.
      “higher layer filtered RSRP” is the SL RSRP measured by the UE receiving the PSSCH/PSCCH transmissions and reported to the UE that transmitted PSSCH/PSCCH. The SL RSRP is measured on PSSCH DMRS and filtered across PSSCH transmission occasions using filter configuration provided by sl-FilterCoefficient.

The UE splits its power equally among antenna ports that have non-zero power.

In one example, in symbols where PSSCH and PSCCH are transmitted, a UE determines a power, P_{PSSCH2}(i), in dBm, for a PSSCH transmission occasion i of a resource pool, on an active SL BWP b of a carrier f, and in symbols where PSSCH and PSCCH are transmitted as:

$${P}_{P S SCH 2} ( i ) = 10 {log}_{10} ( \frac{{M}_{R B}^{P S S C H} ( i ) - {M}_{R B}^{P S C C H} ( i )}{{M}_{R B}^{P S S C H} ( i )} ) + {P}_{P S S C H} ( i )$$

where,
M_{RB}^{PSSCH}(i) is the number of resource blocks for PSSCH transmission occasion i.
M_{RB}^{PSCCH}(i) is the number of resource blocks for PSCCH transmission occasion i.
P_{PSSCH}(i) is the PSSCH power in symbols with no PSCCH.

In one example, a UE determines a power, P_{PSCCH}(i), in dBm, for a PSCCH transmission occasion i of a resource pool, on an active SL BWP b of a carrier f, as:

$${P}_{P S C C H} ( i ) = 10 {log}_{10} ( \frac{{M}_{R B}^{P S C C H} ( i )}{{M}_{R B}^{P S S C H} ( i )} ) + {P}_{P S S C H} ( i )$$

where,
M_{RB}^{PSSCH}(i) is the number of resource blocks for PSSCH transmission occasion i.
M_{RB}^{PSCCH}(i) is the number of resource blocks for PSCCH transmission occasion i.
P_{PSSCH}(i) is the PSSCH power in symbols with no PSCCH.

In one example, a UE has N_{sch,TX,PSFCH} scheduled PSFCH transmissions for HARQ-ACK information and conflict information. The UE is capable of transmitting a maximum of N_{max,PSFCH}. The UE determines N_{TX,PSFCH} PSFCH to transmit, each with a power P_{PSFCH,k}(i), for 1≤k≤N_{TX,PSFCH}, for a PSFCH transmission occasion i of a resource pool, on an active SL BWP b of a carrier f. A UE can be provided with higher layer parameter dl-P0-PSFCH for P0 for DL pathloss based power control for PSFCH. The UE calculates P_{PSFCH,one} in dBm:

$${P}_{PSFCH , one} = {P}_{O , PSFCH} + 10 {log}_{10} ( {2}^{μ} ) + {α}_{PSFCH} \cdot PL$$

where,
P_{O,PSFCH} is the P0 value for DL pathloss based power control for PSFCH. If dl-P0-PSFCH-r17 is configured and supported by the UE it is used for P_{O,PSFCH}, else if dl-P0-PSFCH-r16 is configured it is used for P_{O,PSFCH}, else DL pathloss based power control for PSFCH is disabled, i.e., P_{PSFCH,k}(i)=P_{CMAX}−10 log₁₀(N_{TX,PSFCH}), where P_{CMAX} is determined for N_{TX,PSFCH} transmissions.
   dl-P0-PSFCH-r16 has a range of −16 . . . 15.
   dl-P0-PSFCH-r17 has a range of −202 . . . 24.
μ is the sub-carrier spacing configuration as previously described.
α_{PSFCH} is the alpha value for DL pathloss based power control for PSFCH. This is provided by higher layer parameter dl-Alpha-PSFCH-r16, and is 1 if that parameter is not configured. dl-Alpha-PSFCH-r16 is a value from the set {0, 0.4, 0.5,0.6,0.7,0.8,0.9,1}.
PL is the pathloss, which is given by PL=PL_{b,f,c}(q_{d}) when the active SL BWP is on serving cell c. The RS resource q_{d} for determining the pathloss is given by:
   When the UE is configured to monitor PDCCH for detection of DCI Format 0_0 in serving cell c: RS resource used for determining the power of a PUSCH transmission scheduled by DCI Format 0_0 in serving cell c.
When the UE is not configured to monitor PDCCH for detection of DCI Format 0_0 in serving cell c: RS resource corresponding to SS/PBCH block used by the UE to obtain the MIB.

As described above, the monitoring procedure for resource (re)selection during the sensing window requires reception and decoding of a SCI format during the sensing window as well as measuring the SL RSRP. This reception and decoding process and measuring the SL RSRP increases a processing complexity and power consumption of a UE for sidelink communication and requires the UE to have receive circuitry on the SL for sensing even if the UE transmits and does not receive on the sidelink. The aforementioned sensing procedure is referred to a full sensing.

3GPP Release 16 is the first NR release to include sidelink through work item “5G V2X with NR sidelink”, the mechanisms introduced focused mainly on vehicle-to-everything (V2X), and can be used for public safety when the service requirement can be met. Release 17 extends sidelink support to more use cases through work item “NR Sidelink enhancement” (RP-201385). The objectives of Rel-17 SL include: (1) Resource allocation enhancements that reduce power consumption. (2) Enhanced reliability and reduced latency.

Rel-17 introduced low-power resource allocation. Low-power resource allocation schemes include partial sensing and random resource selection. If a SL transmission from a UE is periodic, partial sensing can be based on periodic-based partial sensing (PBPS), and/or contiguous partial sensing (CPS). If a SL transmission from a UE is aperiodic, partial sensing can be based on CPS and PBPS if the resource pool supports periodic reservations (i.e., sl_multiReserveResource is enabled). When a UE performs PBPS, the UE selects a set of Y slots (Y≥Yₘᵢₙ) within a resource selection window corresponding to PBPS, where Yₘᵢₙ is provided by higher layer parameter minNumCandidateSlotsPeriodic. The UE monitors slots at t′_{y-k×P}_{ᵣₑₛₑᵣᵥₑ}^{SL}, where t′_{y}^{SL} is a slot of the Y selected candidate slots. The periodicity value for sensing for PBPS, i.e., Pᵣₑₛₑᵣᵥₑ is a subset of the resource reservation periods allowed in a resource pool provided by higher layer parameter sl-ResourceReservePeriodList. Pᵣₑₛₑᵣᵥₑ is provided by higher layer parameter periodicSensingOccasionReservePeriodList, if not configured, Pᵣₑₛₑᵣᵥₑ includes periodicities in sl-ResourceReservePeriodList. The UE monitors k sensing occasions determined by additionalPeriodicSensingOccasion, as previously described, and not earlier than n−T₀. For a given periodicity Pᵣₑₛₑᵣᵥₑ, the values of k correspond to the most recent sensing occasion earlier than t′_{y0}^{SL}−(T_{proc,0}^{SL}+T_{proc,1}^{SL}) if additionalPeriodicSensingOccasion is not (pre-)configured and additionally includes the value of k corresponding to the last periodic sensing occasion prior to the most recent one if additionalPeriodicSensingOccasion is (pre-)configured. t′_{y0}^{SL} is the first slot of the selected Y candidate slots of PBPS. When a UE performs CPS, the UE selects a set of Y′ slots (Y′≥Y′ₘᵢₙ) within a resource selection window corresponding to CPS, where Yₘᵢₙ is provided by higher layer parameter minNumCandidateSlotsAperiodic. The sensing window for CPS starts at least M logical slots before t′_{y0}^{SL} (the first of the Y′ candidate slots) and ends at t′_{y0}^{SL}−(T_{proc,0}^{SL}+T_{proc,1}^{SL}).

Rel-17 introduced inter-UE co-ordination (IUC) to enhance the reliability and reduce the latency for resource allocation, where SL UEs exchange information with one another over sidelink to aid the resource allocation mode 2 (re-)selection procedure. UE-A (e.g., UE 111) provides information to UE-B (e.g., UE 111B), and UE-B uses the provided information for its resource allocation mode 2 (re-)selection procedure. IUC addresses is designed to address issues with distributed resource allocation such as: (1) Hidden node problem, where a UE-B is transmitting to a UE-A and UE-B can't sense or detect transmissions from a UE-C(e.g., UE 111C), that interfere with its transmission to a UE-A, (2) Exposed node problem, where a UE-B is transmitting to a UE-A, and UE-B senses or detects transmissions from a UE-C and avoids the resources used or reserved by UE-C, but UE-C doesn't cause interference at UE-A, (3) Persistent collision problem, and (4) Half-duplex problem, where UE-B is transmitting to a UE-A in the same slot that UE-A is transmitting. UE-A will miss the transmission from UE-B as it can't receive and transmit in the same slot.

There are two schemes for inter-UE co-ordination, as described herein.

In one example, in scheme 1, a UE-A can provide to another UE-B indications of resources that are preferred to be included in UE-B's (re-)selected resources or non-preferred resources to be excluded for UE-B's (re-) selected resources. When given preferred resources, UE-B may use those resources for its resource (re-)selection, or it may combine them with resources identified by its own sensing procedure, by finding the intersection of the two sets of resources, for its resource (re-)selection. When given non-preferred resources, UE-B may exclude these resources from resources identified by its own sensing procedure for its resource (re-)selection. Transmissions of co-ordination information (e.g., IUC messages) sent by UE-A to UE-B, and co-ordination information requests for (e.g., IUC requests) sent by UE-B to UE-A, are sent in a MAC-control element (CE) message and may also, if the supported by the UE, be sent in a 2^{nd}-stage SCI Format (SCI Format 2-C). The benefit of using the 2nd stage SCI is to reduce latency. IUC messages from UE-A to UE-B can be sent standalone, or can be combined with other SL data. Coordination information (IUC messages) can be in response to a request from UE-B, or due to a condition at UE-A. An IUC request is unicast from UE-B to UE-A, in response UE-A sends an IUC message in unicast mode to UE-B. An IUC message transmitted as a result of an internal condition at UE-A can be unicast to UE-B, when it includes preferred resources, or can be unicast, groupcast or broadcast to UE-B when it includes non-preferred resources. UE-A can determine preferred or non-preferred resources for UE-B based on its own sensing taking into account the SL-RSRP measurement of the sensed data and the priority of the sensed data, i.e., the priority field of the decoded PSCCH during sensing as well as the priority the traffic transmitted by UE-B in case of request-based IUC or a configured priority in case of condition-based IUC. Non-preferred resource to UE-B can also be determined to avoid the half-duplex problem, where UE-A can't receive data from a UE-B in the same slot UE-A is transmitting.

In another example, in scheme 2, a UE-A can provide to another UE-B an indication that resources reserved for UE-B's transmission, whether or not UE-A is the destination UE, are subject to conflict with a transmission from another UE. UE-A determines the conflicting resources based on the priority and RSRP of the transmissions involved in the conflict. UE-A can also determine a presence of a conflict due to the half-duplex problem, where UE-A can't receive a reserved resource from UE-B at the same time UE-A is transmitting. When UE-B receives a conflict indication for a reserved resource, it can re-select new resources to replace them. The conflict information from UE-A is sent in a PSFCH channel separately (pre-)configured from the PSFCH of the PSFCH of SL-HARQ operation, The timing of the PSFCH channel carrying conflict information can be based on the SCI indicating reserved resource, or based on the reserved resource.

In both schemes, UE-A can identify resources according to a number of conditions which are based on the SL-RSRP of the resources in question as a function of the traffic priority, and/or whether UE-A would be unable to receive a transmission from UE-B, due to performing its own transmission, i.e., a half-duplex problem. The purpose of this exchange of information is to give UE-B information about resource occupancy acquired by UE-A which it cannot determine on its own due to hidden nodes, exposed nodes, persistent collisions, etc.

3GPP Release 16 is the first NR release to include sidelink through work item “5G V2X with NR sidelink”, the mechanisms introduced focused mainly on vehicle-to-everything (V2X) and can be used for public safety when the service requirement can be met. Release 17 extends sidelink support to more use cases through work item “NR Sidelink enhancement” (RP-201385). The objectives of Rel-17 SL include: (1) Resource allocation enhancements that reduce power consumption and (2) enhanced reliability and reduced latency.

Rel-17 introduced low-power resource allocation. Low-power resource allocation schemes include partial sensing and random resource selection. If a SL transmission from a UE is periodic, partial sensing can be based on periodic-based partial sensing (PBPS), and/or contiguous partial sensing (CPS). If a SL transmission from a UE is aperiodic, partial sensing can be based on CPS and PBPS if the resource pool supports periodic reservations (i.e., sl_multiReserveResource is enabled). When a UE (e.g., the UE 111A) performs PBPS, the UE selects a set of Y slots (Y≥Yₘᵢₙ) within a resource selection window corresponding to PBPS, where Yₘᵢₙ is provided by higher layer parameter minNumCandidateSlotsPeriodic. The UE monitors slots at t′_{y-k×P}_{ᵣₑₛₑᵣᵥₑ}^{SL}, where t′_{y}^{SL} is a slot of the Y selected candidate slots. The periodicity value for sensing for PBPS, i.e., Pᵣₑₛₑᵣᵥₑ is a subset of the resource reservation periods allowed in a resource pool provided by higher layer parameter sl-ResourceReservePeriodList. Pᵣₑₛₑᵣᵥₑ is provided by higher layer parameter periodicSensingOccasionReservePeriodList. If not configured, Pᵣₑₛₑᵣᵥₑ includes periodicities in sl-ResourceReservePeriodList. The UE monitors k sensing occasions determined by additionalPeriodicSensingOccasion, as previously described, and not earlier than n−T₀. For a given periodicity Pᵣₑₛₑᵣᵥₑ, the values of k correspond to the most recent sensing occasion earlier than t′_{y0}^{SL}−(T_{proc,0}^{SL}+T_{proc,1}^{SL}) if additionalPeriodicSensingOccasion is not (pre-)configured and additionally includes the value of k corresponding to the last periodic sensing occasion prior to the most recent one if additionalPeriodicSensingOccasion is (pre-)configured. t′_{y0}^{SL} is the first slot of the selected Y candidate slots of PBPS. When a UE performs CPS, the UE selects a set of Y′ slots (Y′≥Y′ₘᵢₙ) within a resource selection window corresponding to CPS, where Y′ₘᵢₙ is provided by higher layer parameter minNumCandidateSlotsAperiodic. The sensing window for CPS starts at least M logical slots before t′_{y0}^{SL} (the first of the Y′ candidate slots) and ends at t′_{y0}^{SL}−(T_{proc,0}^{SL}+T_{proc,1}^{SL}).

Rel-17 introduced inter-UE co-ordination (IUC) to enhance the reliability and reduce the latency for resource allocation, where SL UEs exchange information with one another over sidelink to aid the resource allocation mode 2 (re-)selection procedure. UE-A provides information to UE-B, and UE-B uses the provided information for its resource allocation mode 2 (re-)selection procedure. IUC is designed to address issues with distributed resource allocation such as: (1) Hidden node problem, where a UE-B is transmitting to a UE-A and UE-B can't sense or detect transmissions from a UE-C that interfere with its transmission to a UE-A, (2) Exposed node problem, where a UE-B is transmitting to a UE-A, and UE-B senses or detects transmissions from a UE-C and avoids the resources used or reserved by UE-C, but UE-C doesn't cause interference at UE-A, (3) Persistent collision problem, and (4) Half-duplex problem, where UE-B is transmitting to a UE-A in the same slot that UE-A is transmitting in, UE-A will miss the transmission from UE-B as UE-A cannot receive and transmit in the same slot.

There are two schemes for inter-UE co-ordination.
1. In one example, in scheme 1, a UE-A can provide to another UE-B indications of resources that are preferred to be included in UE-B's (re-)selected resources, or non-preferred resources to be excluded for UE-B's (re-)selected resources. When given preferred resources, UE-B may use those resources for its resource (re-)selection, or UE-B may combine them with resources identified by its own sensing procedure, e.g., by finding the intersection of the two sets of resources, for its resource (re-)selection. When given non-preferred resources, UE-B may exclude these resources from resources identified by its own sensing procedure for its resource (re-)selection. Transmissions of co-ordination information (e.g., IUC messages) sent by UE-A to UE-B, and co-ordination information requests (e.g., IUC requests) sent by UE-A to UE-B, are sent in a MAC-CE message and may also, if supported by the UEs, be sent in a 2^{nd}-stage SCI Format (SCI Format 2-C). The benefit of using the 2nd stage SCI is to reduce latency. IUC messages from UE-A to UE-B can be sent standalone or can be combined with other SL data. Coordination information (IUC messages) can be in response to a request from UE-B, or due to a condition at UE-A. An IUC request is unicast from UE-B to UE-A, in response UE-A sends an IUC message in unicast mode to UE-B. An IUC message transmitted as a result of an internal condition at UE-A can be unicast to UE-B, when the IUC message includes preferred resources, or can be unicast, groupcast or broadcast to UE-B when the IUC message includes non-preferred resources. UE-A can determine preferred or non-preferred resources for UE-B based on its own sensing taking into account the SL-RSRP measurement of the sensed data and the priority of the sensed data, i.e., the priority field of the decoded PSCCH during sensing as well as the priority the traffic transmitted by UE-B in case of request-based IUC or a configured priority in case of condition-based IUC. Non-preferred resource to UE-B can also be determined to avoid the half-duplex problem, where UE-A can't receive data from a UE-B in the same slot UE-A is transmitting.
2. In another example, in scheme 2, a UE-A can provide to another UE-B an indication that resources reserved for UE-B's transmission, whether or not UE-A is the destination UE of these resources, are subject to conflict with a transmission from another UE. UE-A determines the conflicting resources based on the priority and RSRP of the transmissions involved in the conflict. UE-A can also determine a presence of a conflict due to the half-duplex problem, where UE-A can't receive a reserved resource from UE-B at the same time UE-A is transmitting. When UE-B receives a conflict indication for a reserved resource, UE-B can re-select new resources to replace them. The conflict information from UE-A is sent in a PSFCH channel separately (pre-)configured from the PSFCH of the SL-HARQ operation. The timing of the PSFCH channel carrying conflict information can be based on the SCI indicating reserved resource or based on the reserved resource.

In both schemes, UE-A can identify resources according to a number of conditions which are based on the SL-RSRP of the resources in question as a function of the traffic priority, and/or whether UE-A would be unable to receive a transmission from UE-B, due to performing its own transmission, i.e., a half-duplex problem. The purpose of this exchange of information is to give UE-B information about resource occupancy acquired by UE-A which UE-B cannot determine on its own due to hidden nodes, exposed nodes, persistent collisions, etc.

Release 18 considers further evolution of the NR SL air interface for operation in unlicensed bands, beam-based operation in FR2, SL carrier aggregation and co-channel co-existence between LTE SL and NR SL.

For LTE SL, a UE can operate with SL CA for some modes of resource allocation (modes 3 and 4). When operating in CA, a given (sidelink) MAC protocol data unit (PDU) is transmitted, and if necessary re-transmitted, on a single sidelink carrier, and multiple MAC PDUs can be transmitted in parallel on different carriers. This provides a throughput gain in a similar way as for Uu CA. The UE allowed to transmit and receive on multiple sidelink carriers (pre)configured by the network (e.g., the network 130) can select specific sidelink one or more carriers among them for transmission.

SL CA for resource allocation mode 3 using a dynamic grant is similar to the CA operation on the Uu interface that includes a carrier indication field (CIF) in the DCI from the eNB. This indicates which among the up to 8 configured sidelink carriers the allocation in the DCI applies to.

SL CA in resource allocation mode 4 uses a sensing procedure to select resources independently on each involved carrier. The same carrier is used for MAC PDUs of the same SL process at least until the process triggers resource re-selection. Procedures to avoid unexpected UE behavior when the demands of CA become high allow a UE to drop a transmission which uses an excessive amount of resources or transmit chains, or to reject and re-select resources for which it cannot meet the RF requirements under CA.

SL synchronization can also operate on multiple carriers. In addition, in sidelink CA operation, a SyncRef UE uses a single synchronization reference for aggregated carriers and may transmit a sidelink synchronization signal/physical sidelink broadcast channel (SLSS/PSBCH) on one or multiple of them according to capability. A receiving UE likewise uses the same synchronization reference (not necessarily a SyncRef UE) for its aggregated carriers, and it uses the highest priority synchronization reference present among the available synchronization carriers. Another form of CA is packet data convergence protocol (PDCP) duplication, where the same PDCP packet is transmitted in parallel on multiple sidelink carriers, to increase reliability.

For sidelink transmissions, an open-loop power control scheme can be used. A receiving UE does not inform a transmitting UE to increase or decrease the transmission power level. In a first example, the receiving UE can measure an RSRP of a reference signal, for example a DM-RS on a PSSCH, and report the measurement through higher layer signaling to the transmitting UE that can estimate a pathloss of the sidelink transmissions. In a second example the transmitting UE estimates the sidelink pathloss used to determine the power of the sidelink transmissions to be received by the receiving UE from measurements of a reference signal transmitted by the receiving UE. In a third example the transmitting UE estimates the sidelink pathloss using both RSRP measurements of the first and second examples.

To determine the transmission power, based on a configuration the transmitting UE can use the downlink pathloss (between transmitting UE and gNB), the sidelink pathloss (between transmitting UE and receiving UE), or both downlink pathloss and sidelink pathloss. The configuration can be the same for PSSCH, PSSCH and PSFCH, resulting in the same power for symbols used for PSSCH, PSSCH and PSFCH in a slot, or can be different. For example, a first configuration to use both the sidelink pathloss and the downlink pathloss can apply to the transmit power control of PSSCH and PSCCH, and a second configuration to use the downlink pathloss can apply to the transmit power control of PSFCH. For the UE configured to use both downlink pathloss and sidelink pathloss to determine the transmission power of the sidelink channel(s), the transmission power can be determined as the minimum (or the maximum) value among the sidelink transmission power derived from the sidelink pathloss, and the downlink transmission power derived from the downlink pathloss.

When the transmission power is determined, the total sidelink transmission power is the same in the symbols used for PSCCH and PSSCH transmissions in a slot. For the transmission power of PSFCH, an open-loop power control is also adopted in which a receiving UE estimates a pathloss from a gNB to determine the transmission power. A transmitting UE may provide its location information to the receiving UE (conveyed by the 2nd-stage SCI. The receiving UE may not transmit ACK/NACK on the PSFCH if the pathloss is above a threshold.

Aspects, features, and advantages of the disclosure are readily apparent from the following detailed description, simply by illustrating a number of particular embodiments and implementations, including the best mode contemplated for carrying out the present disclosure. The disclosure is also capable of other and different embodiments, and its several details can be modified in various obvious respects, all without departing from the spirit and scope of the present disclosure. Accordingly, the drawings and description are to be regarded as illustrative in nature, and not as restrictive. The disclosure is illustrated by way of example, and not by way of limitation, in the figures of the accompanying drawings.

A description of example embodiments is provided on the following pages.

The text and figures are provided solely as examples to aid the reader in understanding the present disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this present disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In SL, “reference RS” can correspond to a set of characteristics for SL beam, such as a direction, a precoding/beamforming, a number of ports, and so on. This can correspond to a SL receive beam or to a SL transmit beam. At least two UEs are involved in a SL communication. The present disclosure refers to a first UE as UE-A and to second UE as UE-B. In one example, UE-A is transmitting SL data on PSSCH/PSCCH, and UE-B is receiving the SL data on PSSCH/PSCCH.

In this disclosure, RRC signaling (e.g., configuration by RRC signaling) includes the following: (1) RRC signaling over the Uu interface, this can be system information block (SIB)-based RRC signaling (e.g., SIB1 or other SIB) or RRC dedicated signaling that is sent to a specific UE, and/or (2) PC5-RRC signaling over the PC5 or SL interface.

In this disclosure MAC CE signaling includes: (1) MAC CE signaling over the Uu interface, and/or (2) MAC CE signaling over the PC5 or SL interface.

In this disclosure L1 control signaling includes: (1) L1 control signaling over the Uu interface, this can include (1a) DL control information (e.g., DCI on PDCCH) and/or (1b) UL control information (e.g., uplink control information (UCI) on physical uplink control channel (PUCCH) or PUSCH), and/or (2) SL control information over the PC5 or SL interface, this can include (2a) first stage sidelink control information (e.g., first stage SCI on PSCCH), and/or (2b) second stage sidelink control information (e.g., second stage SCI on PSSCH) and/or (2c) feedback control information (e.g., control information carried on PSFCH).

In this disclosure, a carrier from the multiple carriers for SL CA can be identified for communication between a first UE and a second UE. In one example for the first UE, a same carrier is used to transmit PSSCH/PSCCH and PSFCH from the first UE to the second UE. In one example, for the first UE, a same carrier is used to receive PSSCH/PSCCH and PSFCH at the first UE from the second UE. In one example for the first UE, different carriers are used to transmit PSSCH/PSCCH and PSFCH from the first UE to the second UE. In one example, for the first UE, different carriers are used to receive PSSCH/PSCCH and PSFCH at the first UE from the second UE. In one example for the first UE, different carriers are used to transmit PSSCH and PSCCH from the first UE to the second UE. In one example, for the first UE, different carriers are used to receive PSSCH and PSCCH at the first UE from the second UE. The roles of the first and second UEs can be interchanged.

In this disclosure, without the loss of any generality, UE-A is the SL UE transmitting PSSCH/PSCCH or receiving PSFCH and UE-B is the SL UE receiving PSSCH/PSCCH or transmitting PSFCH. Communication has been established between UE-A and UE-B (e.g., for PSSCH/PSCCH or PSFCH) and a carrier or a carrier pair has been determined, e.g., UE-A transmits PSSCH/PSCCH on a first carrier and UE-B receives PSSCH/PSCCH on the first carrier or a second carrier.

The following descriptions and embodiments for a UE configured for sidelink operation on multiple carriers equally apply or are easily adaptable to operations on multiple BWPs, wherein one or more BWPs are for sidelink for transmissions and/or receptions and one or more BWP are for uplink and/or downlink; or on multiple sub-bands of a BWP, wherein: a first sub-band of the BWP can be for transmissions and a second sub-band of the BWP can be for receptions, the multiple sub-bands can be more than two, the multiple sub-bands can be non-overlapping or can be partially or entirely overlapping, the multiple sub-band can be of same or different width, a sub-band from the multiple sub-bands can be for transmission in a first time period (e.g., one or more symbols, or one or more slots, or one or more frames, etc.) and can be for reception in a second time period, with first and second time periods of same or different duration, a sub-band can be for transmission and/or reception for sidelink, and a second sub-band can be for uplink and/or downlink; and each BWP can include more than one band for transmission or for reception.

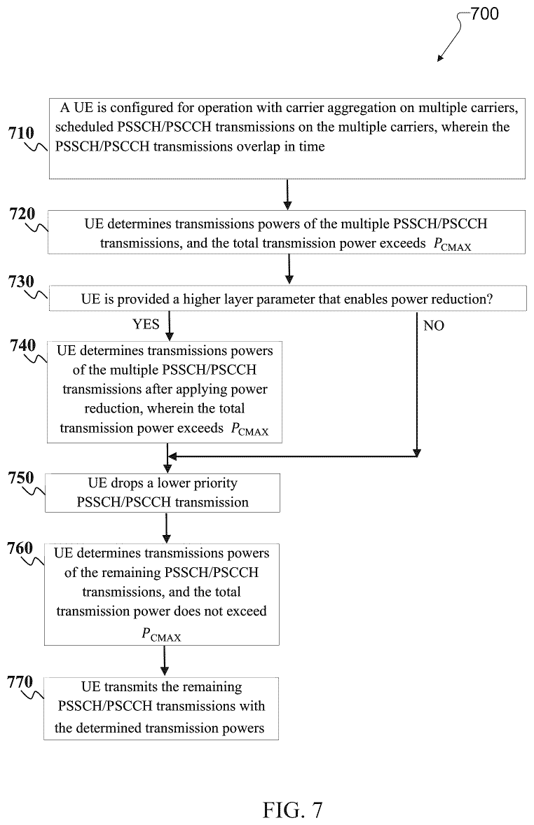

FIG. 7 illustrates a flowchart of an example UE procedure 700 for transmitting a PSSCH/PSCCH on a sidelink carrier according to embodiments of the present disclosure. For example, procedure 700 for transmitting a PSSCH/PSCCH on a sidelink carrier can be performed by any of the UEs 111-111C, such as the UE 111A of FIG. 1. This example is for illustration only and other embodiments can be used without departing from the scope of the present disclosure.

The procedure begins in 710, a UE is configured for operation with carrier aggregation on multiple carriers, and scheduled PSSCH/PSCCH transmissions on the multiple carriers, wherein the PSSCH/PSCCH transmissions overlap in time. In 720, the UE determines transmissions powers of the multiple PSSCH/PSCCH transmissions, and the total transmission power exceeds P_{CMAX}. In 730, when the UE is provided a higher layer parameter that enables power reduction, then in 740, the UE determines transmissions powers of the multiple PSSCH/PSCCH transmissions after applying power reduction, wherein the total transmission power exceeds P_{CMAX}. Otherwise, in 730, when the UE is not provided a higher layer parameter that enables power reduction, the procedure continues in 750. In 750, the UE drops a lower priority PSSCH/PSCCH transmission. In 760, the UE determines transmissions powers of the remaining PSSCH/PSCCH transmissions, wherein the total transmission power does not exceed P_{CMAX}. In 770, the UE transmits the remaining PSSCH/PSCCH transmissions with the determined transmission powers.

When a UE is configured for operation with carrier aggregation on multiple carriers for SL (e.g., PC5) interface, and the UE (e.g., the UE 111A) would simultaneously transmit and/or receive on the SL in more than one SL carriers, whether the UE simultaneously transmits and/or receives on the SL in more than one SL carriers is subject to a UE capability of transmitting and/or receiving simultaneously on more than one SL carriers and/or to a maximum total UE transmission power.

In one example, when a UE is configured for operation with carrier aggregation on multiple carriers for SL, and the UE would simultaneously transmit on the SL in more than one SL carriers, if the UE is not capable of simultaneous transmissions on the SL carriers, the UE transmits on the SL carrier with the higher priority.

In one example, when a UE is configured for operation with carrier aggregation on multiple carriers for SL, and the UE would simultaneously transmit on the SL in more than one SL carriers, if the UE is not capable of simultaneous transmissions on the SL carriers, the UE transmits on the SL carrier with the higher priority, and postpones the transmission on the SL carrier with the lower priority.

In one example, when a UE is configured for operation with carrier aggregation on two carriers for SL, and the UE would simultaneously transmit on a first SL carrier and receive on a second SL carrier, if the UE is not capable of simultaneous transmission and reception on the first and second SL carriers, respectively, the UE transmits or receives on the SL carrier with the higher priority.

In one example, when a UE is configured for operation with carrier aggregation on two carriers for SL, and the UE would simultaneously transmit on a first SL carrier and receive on a second SL carrier, if the UE is not capable of simultaneous transmission and reception on the first and second SL carriers, respectively, the UE transmits or receives on the SL carrier with the higher priority, and if the reception is on the SL carrier with the higher priority, the UE postpones the transmission on the SL carrier with the lower priority.

In one example, when a UE is configured for operation with carrier aggregation on two carriers for SL, and the UE (e.g., the UE 111A) would simultaneously transmit on the SL in the two SL carriers, if the UE is capable of simultaneous transmissions on two SL carriers, a first transmission on a first SL carrier overlaps with a second transmission on a second SL carrier over a time period, and the total UE transmission power over the time period would exceed P_{CMAX}, the UE transmits on the SL carrier with the higher priority.

In one example, when a UE is configured for operation with carrier aggregation on two carriers for SL, and the UE would simultaneously transmit on the SL in the two SL carriers, if the UE is capable of simultaneous transmissions on two SL carriers, a first transmission on a first SL carrier overlaps with a second transmission on a second SL carrier over a time period, and the total UE transmission power over the time period would exceed P_{CMAX}, the UE can reduce the transmission power on one carrier or both carriers as follows.

In a first sub-example, the UE reduces the power for the first SL transmission prior to the start of the first SL transmission, if the second SL transmission has higher priority than the first SL transmission, so that the total UE transmission power would not exceed P_{CMAX}.

In a second sub-example, the UE reduces the power for the second SL transmission prior to the start of the second SL transmission, if the first SL transmission has higher priority than the second SL transmission, so that the total UE transmission power would not exceed P_{CMAX}.

In a third sub-example, the UE reduces the power for the first and second SL transmissions prior to the start of the first and second SL transmissions, if the first and second SL transmissions have same priority, so that the total UE transmission power would not exceed P_{CMAX}, wherein the power is reduced for the first and second SL transmissions of the same amount in dB or of the same percentage.

In a fourth sub-example, the UE reduces the power for the first and second SL transmissions prior to the start of the first and second SL transmissions, and the power reduction for the second SL transmission is larger than the power reduction of the first SL transmission, if the first SL transmission has higher priority than the second SL transmission, so that the total UE transmission power would not exceed P_{CMAX}. For example, the power of the second transmission is reduced of a larger percentage than the percentage used to reduce the power of the first transmission.

In one example, when a UE is configured for operation with carrier aggregation on more than two carriers for SL interface, and the UE would simultaneously transmit on the SL in more than two SL carriers, if the UE is capable of simultaneous transmissions on two SL carriers, more than two transmissions on more than two respective SL carriers overlap over a time period, the UE determines a first and a second SL transmissions over a first and a second respective SL carriers that have higher priority than other overlapping SL transmissions. If the total UE transmission power of the two determined SL carriers over the time period would exceed P_{CMAX}, based on a configuration the UE can transmit on the SL carrier with higher priority, or the UE can reduce the transmission power on one carrier or both carriers as in the following sub-examples.

In a first sub-example, the UE reduces the power for the first SL transmission prior to the start of the first SL transmission, if the second SL transmission has higher priority than the first SL transmission, so that the total UE transmission power would not exceed P_{CMAX}.

In a second sub-example, the UE reduces the power for the second SL transmission prior to the start of the second SL transmission, if the first SL transmission has higher priority than the second SL transmission, so that the total UE transmission power would not exceed P_{CMAX}.

In a third sub-example, the UE reduces the power for the first and second SL transmission prior to the start of the first and second SL transmissions, if the first and second SL transmissions have same priority, so that the total UE transmission power would not exceed P_{CMAX}, wherein the power is reduced of the same amount or of the same percentage for the first and second SL transmissions.

In a fourth sub-example, the UE reduces the power for the first and second SL transmissions prior to the start of the first and second SL transmissions, and the power reduction for the second SL transmission is larger than the power reduction of the first SL transmission, if the first SL transmission has higher priority than the second SL transmission, so that the total UE transmission power would not exceed P_{CMAX}. For example, the power of the second transmission is reduced of a larger percentage than the percentage used to reduce the power of the first transmission.

A UE can be provided by higher layer an information for enabling a power reduction on a lower priority transmission or on more than one lower priority transmissions when the total UE transmission power would exceed P_{CMAX}, wherein the power reduction is determined by the UE based on a pathloss measured on the corresponding carrier, or based on the determined power for the SL transmission on the corresponding SL carrier. The UE may be provided by higher layers a maximum power reduction that can be applied on a corresponding SL carrier. After applying power reduction on one or more SL transmissions, if the total UE transmission power would exceed P_{CMAX}, the UE drops the transmission with the lower priority.

The power reduction can be enabled for PSSCH/PSCCH transmission but not for PSFCH transmissions. In one example, if two or more PSSCH/PSCCH transmissions on corresponding two or more carriers overlap in time and the total UE transmission power would exceed P_{CMA}X, if power reduction is enabled, the UE can apply power reductions on the two or more of the PSSCH/PSCCH transmissions. In one example, if a PSSCH/PSCCH transmissions on a carrier overlaps with a PSFCH transmission on another carrier and the total UE transmission power would exceed P_{CMAX}, if power reduction is enabled, the UE reduces the power of the PSSCH/PSCCH transmission. After applying power reduction on one or more SL transmissions, if the total UE transmission power would exceed P_{CMAX}, the UE drops the transmission with the lower priority. After dropping a SL transmission, if the total UE transmission power would exceed P_{CMAX}, the UE drops the transmission with the lower priority among the remaining SL transmissions without applying power reduction.

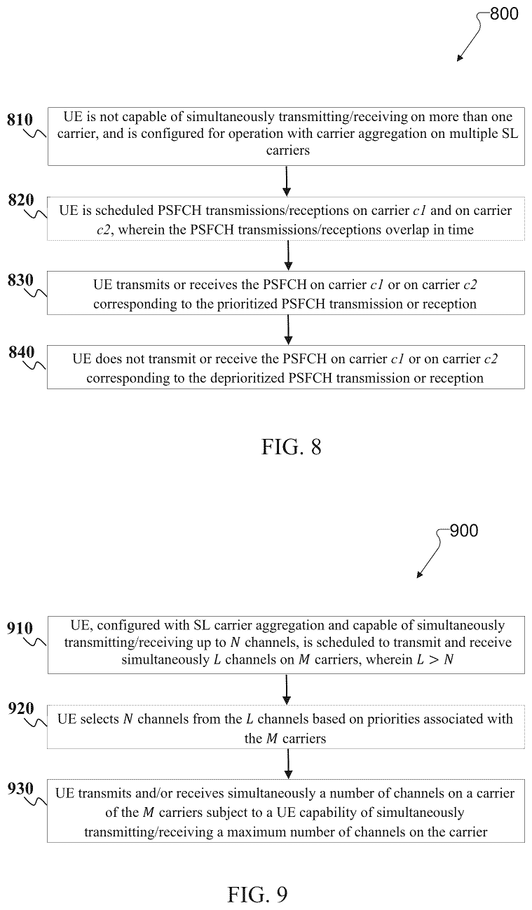

FIG. 8 illustrates a flowchart of an example UE procedure 800 for transmitting a PSSCH/PSCCH on a sidelink carrier according to embodiments of the present disclosure. For example, procedure 800 for transmitting a PSSCH/PSCCH on a sidelink carrier can be performed by any of the UEs 111-111C, such as the UE 111C of FIG. 1. This example is for illustration only and other embodiments can be used without departing from the scope of the present disclosure.

The procedure begins in 810, a UE is not capable of simultaneously transmitting/receiving on more than one carrier, and is configured for operation with carrier aggregation on multiple SL carrier. In 820, the UE is scheduled PSFCH transmissions/receptions on carrier c1 or on carrier c2, wherein the PSFCH transmissions/receptions overlap in time. In 830, the UE transmits or receives the PSFCH on carrier c1 or on carrier c2 corresponding to the prioritized PSFCH transmission or reception. In 840, the UE does not transmit or receive the PSFCH on carrier c1 or on carrier c2 corresponding to the deprioritized PSFCH transmission or reception.

When a UE is configured for operation with carrier aggregation on multiple carriers for SL (e.g., PC5) interface, and the UE would simultaneously transmit/receive PSFCHs on two or more SL carriers, if the UE is not capable of simultaneously transmitting/receiving PSFCHs or more than a maximum number of PSFCHs, there is a need to prioritize PSFCH transmissions/receptions on the multiple carriers.

For each carrier c, for a PSFCH transmission or reception with HARQ-ACK information, a priority value for the PSFCH is equal to the priority value indicated by an SCI format 1-A transmitted/received on the carrier c and associated with the PSFCH. Alternatively, the priority value can be indicated by an SCI format transmitted/received on a carrier other than the carrier c.

For each carrier c, for PSFCH transmission with conflict information, a priority value for the PSFCH is equal to the smallest priority value determined by the corresponding SCI format(s) 1-A transmitted/received on the carrier c for the conflicting resource(s). Alternatively, the priority value can be indicated by an SCI format transmitted/received on a carrier other than the carrier c.

For each carrier c, for PSFCH reception with conflict information, a priority value for the PSFCH is equal to the priority value determined by the corresponding SCI format 1-A transmitted/received on the carrier c for the conflicting resource. Alternatively, the priority value can be indicated by an SCI format transmitted/received on a carrier other than the carrier c.

In one example, if a UE:
would transmit N_{sch,Tx,PSFCH} PSFCHs on carrier c1 and receive N_{sch,Rx,PSFCH} PSFCHs on carrier c2, and transmissions of the N_{sch,Tx,PSFCH} PSFCHs on carrier c1 would overlap in time with receptions of the N_{sch,Rx,PSFCH} PSFCHs on carrier c2; and
is not able of transmitting on carrier c1 and receiving on carrier c2 simultaneously, the UE transmits or receives a set of PSFCHs on carrier c1 or on carrier c2 corresponding to the smallest priority field value, as determined by a first set of SCI format 1-A on carrier c1 and/or a second set of SCI format 1-A on carrier c2 that are respectively associated with PSFCHs with HARQ-ACK information from the N_{sch,Tx,PSFCH} PSFCHs on carrier c1 and PSFCHs with HARQ-ACK information from the N_{sch,Rx,PSFCH} PSFCHs on carrier c2 when one or more of the PSFCHs provide HARQ-ACK information. If none of the N_{sch,Tx,PSFCH} PSFCHs on carrier c1 and none of the N_{sch,Rx,PSFCH} PSFCHs on carrier c2 provide HARQ-ACK information, the UE transmits or receives a set of PSFCHs on carrier c1 or on carrier c2 corresponding to the smallest priority value of the first set of PSFCHs on carrier c1 and the second set of PSFCHs on carrier c2 that are respectively associated with the N_{sch,Tx,PSFCH} PSFCHs on carrier c1 and the N_{sch,Rx,PSFCH} PSFCHs on carrier c2 when the PSFCHs provide conflict information.

On carrier c1, if a UE would transmit N_{sch,TX,PSFCH} PSFCHs in a PSFCH transmission occasion, the UE first transmits PSFCHs with HARQ-ACK information from N_{Tx,PSFCH} PSFCHs corresponding to the smallest priority field values from the N_{Tx,PSFCH} priority field values, if any. Subsequently, the UE transmits remaining PSFCHs with conflict information corresponding to the smallest remaining priority field values from the N_{Tx,PSFCH} priority field values, if any.

On carrier c2, if a UE indicates a capability to receive N_{Rx,PSFCH} PSFCHs in a PSFCH reception occasion, the UE first receives PSFCHs with HARQ-ACK information, if any, and subsequently receives PSFCHs with conflict information, if any.

On carrier c1, PSFCH transmissions in a slot have a same priority value as the smallest priority value among PSSCH receptions with corresponding HARQ-ACK information provided by the PSFCH transmissions in the slot, if any, and among PSFCH transmissions with conflict information in the slot, if any, where each priority value is equal to the smallest priority value determined by corresponding SCI formats 1-A.

On carrier c2, PSFCH receptions in a slot have a same priority value as the smallest priority value among PSSCH transmissions with corresponding HARQ-ACK information provided by the PSFCH receptions in the slot, if any, and among PSFCH receptions with conflict information in the slot, if any, where each priority value is equal to the priority value determined by corresponding SCI format 1-A.

When a UE is configured for operation with carrier aggregation on multiple carriers for SL (e.g., PC5) interface, and the UE would simultaneously transmit/receive PSFCHs on two or more SL carriers, the UE can be also configured to postpone a PSFCH transmission and/or a PSFCH reception if the UE cannot simultaneously transmit/receive PSFCHs on two or more SL carriers. The UE not being able to simultaneously transmit/receive PSFCHs on two or more SL carriers can be due to a UE capability that restricts the number of SL carriers for simultaneously transmitting/receiving PSFCHs, and the number can be 1 or larger.

In one example, if a UE would transmit a PSFCH on carrier c1 and receive a PSFCH on carrier c2, and transmissions of the PSFCH on carrier c1 would overlap in time with receptions of the PSFCH on carrier c2, and is not capable of transmitting on carrier c1 and receiving on carrier c2 simultaneously, the UE transmits or receives the PSFCH on carrier c1 or on carrier c2 corresponding to the smallest priority field value, as determined by a first SCI format 1-A on carrier c1 and/or a second SCI format 1-A on carrier c2 that are respectively associated with PSFCH with HARQ-ACK information from the PSFCH on carrier c1 and PSFCH with HARQ-ACK information from the PSFCH on carrier c2 when the PSFCHs provide HARQ-ACK information. Additionally, the UE may postpone transmission or reception of the PSFCH on carrier c1 or on carrier c2 that was not transmitted or received based on the priority field, and the postponed transmission or reception can be on the same carrier where originally scheduled or on a different carrier from the carrier where originally scheduled. A procedure for postponing the reception of the PSFCH on carrier c2 may comprise a signaling from the UE to request a retransmission of the PSFCH on carrier c2 in a next PSFCH transmission occasion. The prioritization of the transmission or reception of the PSFCH on carrier c1 or on carrier c2 may be based on a configured priority associated with the carrier, and the UE would transmit or receive the PSFCH on the prioritized carrier and postpone transmission or reception of the PSFCH on the deprioritizes carrier.

When PSFCH transmissions or receptions on more than two carriers overlap, and a UE is not capable of transmitting or receiving simultaneously on more than one carrier, the UE (e.g., the UE 111A) transmits or receives the PSFCH on a first carrier corresponding to the smallest priority field value, as determined by the SCI format 1-A on each of the more than two carriers, or corresponding to the prioritized carrier according to the configuration, and postpones one or more PSFCH transmissions or receptions on the one or more carriers different than the first carrier. The UE may postpone one PSFCH transmission or reception corresponding to the second smallest priority field value, as determined by the SCI format 1-A on each of the more than two carriers, or corresponding to the second prioritized carrier according to the configuration, and not transmit or receive PSFCHs on the remaining carriers. The UE may postpone a number of PSFCH transmissions or receptions on corresponding number of carriers different than the first carrier, and the corresponding number is provided by a configuration. The PSFCHs may provide HARQ-ACK information or conflict information.

When PSFCH transmissions or receptions on a first number carriers overlap, and a UE is capable of transmitting or receiving on a second number of carriers, and the second number is smaller than the first number, the UE transmits or receives the PSFCHs on the first number of carriers corresponding to the smallest priority field values, as determined by the SCI format 1-A on each of the more than two carriers, or corresponding to the prioritized carriers according to the configuration, and postpones PSFCH transmissions or receptions on the remaining carriers. The UE may postpone one PSFCH transmission or reception corresponding to the smallest priority field value, as determined by the SCI format 1-A on each of the remaining carriers, or corresponding to the prioritized carrier among the remaining carriers according to the configuration. The PSFCHs may provide HARQ-ACK information or conflict information.

In one example, if a UE would transmit a PSFCH on carrier c1 and receive a PSFCH on carrier c2 and transmissions of the PSFCH on carrier c1 would overlap in time with receptions of the PSFCH on carrier c2, and the UE is not capable of transmitting on carrier c1 and receiving on carrier c2 simultaneously:
when the PSFCHs provide HARQ-ACK information, the UE transmits or receives the PSFCH on carrier c1 or on carrier c2 corresponding to the smallest priority field value, as determined by a first SCI format 1-A on carrier c1 and/or a second SCI format 1-A on carrier c2 that are respectively associated with PSFCH on carrier c1 and PSFCH on carrier c2; and
when the PSFCHs provide conflict information, the UE transmits or receives the PSFCH on carrier c1 or on carrier c2 corresponding to the smallest priority field value, as determined by a first SCI format 1-A on carrier c1 and/or a second SCI format 1-A on carrier c2 that are respectively associated with PSFCH on carrier c1 and PSFCH on carrier c2, and postpones the PSFCH transmission or reception on the other carrier.

A SL UE that supports transmissions and receptions on multiple carriers can have a first capability associated with a first maximum number of simultaneous transmissions and receptions per carrier, and a second capability associated with a second maximum number of simultaneous transmissions and receptions over the multiple carriers. In one example, the UE capability can be associated with simultaneous SL transmissions, or with simultaneous SL receptions, or with simultaneous SL transmissions and SL receptions. In one example, the UE capability can be associated with simultaneous SL and UL transmissions, or with simultaneous SL and DL receptions, or with simultaneous SL and UL transmissions and SL and DL receptions.

FIG. 9 illustrates a flowchart of an example UE procedure 900 for transmitting/receiving on multiple sidelink carriers according to embodiments of the present disclosure. For example, procedure 900 for transmitting/receiving on multiple sidelink carriers can be performed by any of the UEs 111-111C, such as the UE 111A. This example is for illustration only and other embodiments can be used without departing from the scope of the present disclosure.

The procedure begins in 910, a UE, configured with SL carrier aggregation and capable of simultaneously transmitting/receiving up to N channels, is scheduled to transmit and receive simultaneously L channels on M carriers, wherein L>N. In 920, the UE selects N channels from the L channels based on priorities associated with the M carriers. In 930, the UE transmits and/or receives simultaneously a number of channels on a carrier of the M carriers subject to a UE capability of simultaneously transmitting/receiving a maximum number of channels on the carrier.

With reference to FIG. 9, an example procedure for a UE to transmit/receive on multiple SL carriers subject to a first UE capability of simultaneously transmitting/receiving a maximum number of channels per carrier and/or to a second UE capability of simultaneously transmitting/receiving a maximum number of channels over the multiple SL carriers is shown.

In one example, if a UE1 would simultaneously receive a first PSFCH and a second PSFCH on a carrier c1, and the UE1 is not capable of receiving the first PSFCH and the second PSFCH simultaneously, for example due to a total number of simultaneous transmissions and receptions exceeding a maximum number that is subject to a UE capability, the UE1 receives the first PSFCH based on a priority associated with a corresponding first PSSCH. Additionally, UE1 sends a request to UE2 to retransmit the second PSFCH in SCI-format 1-A, SCI format 2-A or SCI format 2-B, or UE1 resends the PSSCH associated with the second PSFCH.

In one example, if a UE1 would simultaneously receive a first PSFCH on carrier c1 and a second PSFCH on carrier c2, and the UE1 is not capable of receiving the first PSFCH and the second PSFCH simultaneously, for example due to a total number of simultaneous transmissions and receptions exceeding a maximum number that is subject to a UE capability, the UE1 receives the first PSFCH on carrier c1 that has a higher priority than the second PSFCH on carrier c2. Additionally, UE1 sends a request to UE2 to retransmit the second PSFCH in SCI-format 1-A, SCI format 2-A or SCI format 2-B, or UE1 resends the PSSCH associated with the second PSFCH.

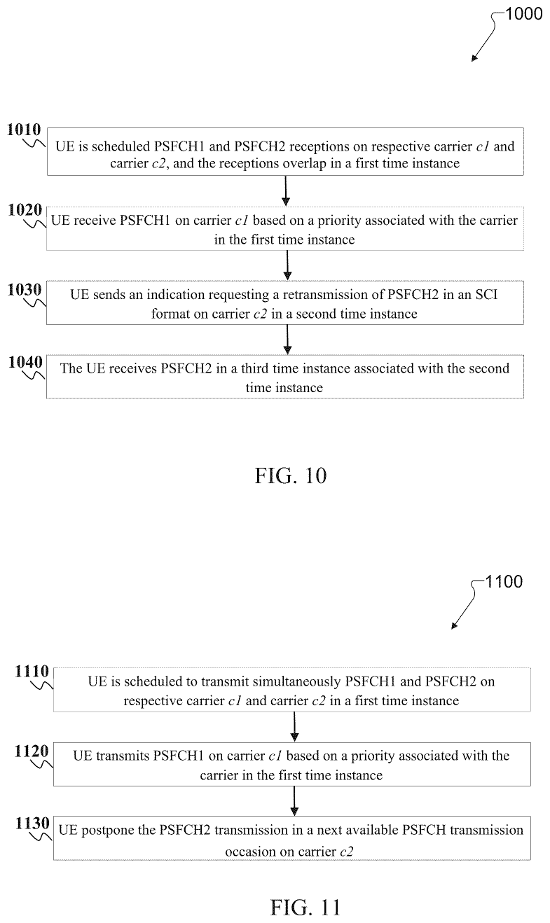

FIG. 10 illustrates a flowchart of an example UE procedure 1000 for sidelink operation on multiple carriers to postpone a PSFCH reception according to embodiments of the present disclosure. For example, procedure 1000 for sidelink operation on multiple carriers to postpone a PSFCH reception can be performed by any of the UEs 111-111A of FIG. 1, such as the UE 111B. This example is for illustration only and other embodiments can be used without departing from the scope of the present disclosure.

The procedure begins in 1010, a UE is scheduled PSFCH1 and PSFCH2 receptions on respective carrier c1 and carrier c2, and the receptions overlap in a first time instance. In 1020, the UE receive PSFCH1 on carrier c1 based on a priority associated with the carrier in the first time instance. In 1030, the UE sends an indication requesting a retransmission of PSFCH2 in an SCI format on carrier c2 in a second time instance. In 1040, the UE receives PSFCH2 in a third time instance associated with the second time instance.

FIG. 11 illustrates a flowchart of an example UE procedure 1100 for sidelink operation on multiple carriers to postpone a PSFCH transmission according to embodiments of the present disclosure. For example, procedure 1100 for sidelink operation on multiple carriers can be performed by any of the UEs 111-111A of FIG. 1, such as the UE 111C. This example is for illustration only and other embodiments can be used without departing from the scope of the present disclosure.

The procedure begins in 1110, a UE is scheduled to transmit simultaneously PSFCH1 and PSFCH2 on respective carrier c1 and carrier c2 in a first time instance. In 1120, the UE transmits PSFCH1 on carrier c1 based on a priority associated with the carrier in the first time instance. In 1130, the UE postpones the PSFCH2 transmission in a next available PSFCH transmission occasion on carrier c2.

When a UE is configured for operation with carrier aggregation on multiple carriers for SL (e.g., PC5) interface, and the UE would simultaneously transmit and/or receive on the UL and on the SL in more than one SL carriers, whether the UE simultaneously transmits and/or receives on the UL and on the SL in more than one SL carriers is subject to a UE capability of transmitting and/or receiving simultaneously on the UL and on the SL in more than one SL carriers and/or to a maximum total UE transmission power.

In one example, when a UE is configured for operation with carrier aggregation on multiple carriers for SL, and the UE would simultaneously transmit on the UL and on the SL in more than one SL carriers:
if the UE is not capable of simultaneous transmissions, the UE transmits on one carrier with higher priority;
if the UE is not capable of simultaneous transmissions on UL and SL, the UE transmits on the UL or the SL with higher priority;
if the UE is not capable of simultaneous transmissions on the UL and SL, and is capable of simultaneous transmissions on the SL, the UE first determines the priority between UL and SL, and if the SL has higher priority, the UE transmits in the more than one SL carriers if the total UE transmission power would not exceed P_{CMAX}.

In one example, when a UE is configured for operation with carrier aggregation on two carriers for SL, and the UE would simultaneously transmit on the UL and on a first SL carrier and receive on a second SL carrier, if the UE is not capable of simultaneous transmission and reception on the first and second SL carriers, the UE transmits or receives on the SL carrier with the higher priority.

In one sub-example, based on the higher priority of the SL transmission on the first SL carrier respect to the SL reception on the second SL carrier, if the UE is capable of transmitting simultaneously on the first SL carrier and on the UL carrier, and the total UE transmission power would not exceed P_{CMAX}, the UE transmits on the UL carrier and on the first SL carrier. If the total UE transmission power would exceed P_{CMAX}, the UE transmits on UL or SL with the higher priority, or the UE reduces the transmission power on the UL carrier or on the SL carrier or on both UL and SL carriers based on the priority of the UL and SL transmissions as described herein for two SL transmissions on two SL carriers.

In one sub-example, based on the higher priority of the SL reception on the second SL carrier respect to the SL transmission on the first SL carrier, if the UE is capable of simultaneously transmitting on the UL and receiving on the SL, the UE transmits on the UL carrier and receives on the second SL carrier. Otherwise, the UE transmits on the UL carrier or receives on the second SL carrier based on the UL or SL higher priority.

In one example, when a UE is configured for operation with carrier aggregation on multiple carriers for SL, and the UE would simultaneously transmit on the UL and on the SL in more than one SL carriers, if the UE is not capable of simultaneous transmissions, the UE transmits on one carrier with higher priority among the UL and SL carriers, and postpones the transmission on one or more of the remaining carriers with lower priority according to a configuration. For example, if the UE is not capable of simultaneous transmissions and is scheduled to transmit on the UL carrier and on a first and a second SL carrier, and the UL transmission has priority over the SL transmissions, the UE transmits on the UL carrier and postpones the SL transmissions on the first SL carrier and on the second SL carrier to next transmission occasions for the channel in the respective carriers. Alternatively, only the SL transmission with higher priority is postponed and the other SL transmission is canceled.

Prioritization between UL and SL transmissions/receptions can be based on priorities associated with the carrier. For example, the UL carrier has higher priority than the SL carrier or a first SL carrier has higher priority than a second SL carrier or than the remaining SL carriers that have same priority, and/or on priorities associated with the channel type. For example, a PSFCH has higher priority than a PSCCH/PSSCH.

For example, the UE may select the carrier with the highest priority, then select the channels on the highest priority carrier, and then select the carrier with the second highest priority and so on, until the maximum number of simultaneous transmissions is reached, or the maximum transmit power is reached or exceeded.

For example, the UE may select the channels with the highest priority in all carriers, e.g., a first number of PSFCHs. If the first number of PSFCHs is larger than the maximum number of simultaneous transmissions or a maximum transmit power P_{CMAX} is exceeded, the UE orders the channels based on the priority associated with the carrier, if any, and selects a second number of channels with highest priorities so that the second number is not larger than the maximum number or the maximum transmit power P_{CMAX} is not exceeded; otherwise, the UE selects also a third number of channels with the second highest priority in all carriers, if any. If the third number is larger than zero, then the UE considers both first number of channels and third number of channels in the procedure as above described for the first number of channels.

In one example, when a UE is configured for operation with carrier aggregation on multiple carriers for SL, and the UE would simultaneously transmit on the UL and on the SL in more than one SL carriers, if the UE is not capable of simultaneous transmissions on UL and SL, the UE transmits on the UL or the SL with higher priority, and postpones transmissions on the link with lower priority.

In one example, when a UE is configured for operation with carrier aggregation on multiple carriers for SL, and the UE would simultaneously transmit on the UL and on the SL in more than one SL carriers, if the UE is not capable of simultaneous transmissions on the UL and SL, and is capable of simultaneous transmissions on the SL, the UE first determines the priority between UL and SL, and if the SL has higher priority, the UE transmits in the more than one SL carriers if the total UE transmission power would not exceed P_{CMAX}, and postpones transmission on the UL.

The descriptions herein also apply to simultaneous DL and SL receptions.

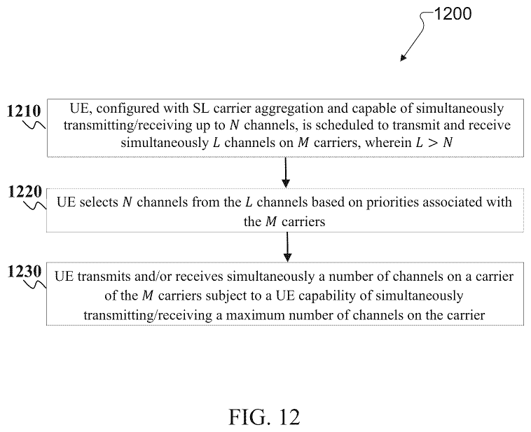

FIG. 12 illustrates a flowchart of an example UE procedure 1200 for prioritizing between uplink and sidelink transmissions/receptions according to embodiments of the present disclosure. For example, procedure 1200 for prioritizing between uplink and sidelink transmissions/receptions can be performed by any of the UEs 111-111A of FIG. 1, such as the UE 111. This example is for illustration only and other embodiments can be used without departing from the scope of the present disclosure.

The procedure begins in 1210, a UE is configured for UL transmission and for sidelink operation on multiple carriers, and is capable of simultaneously transmitting/receiving up to N channels. In 1220, the UE selects N channels from the L channels based on priorities associated with the M carriers. In 1230, the UE transmits and/or receives simultaneously a number of channels on a carrier of the M carriers subject to a UE capability of simultaneously transmitting/receiving a maximum number of channels on the carrier.

When a UE is configured for operation with carrier aggregation on multiple carriers for SL (e.g., PC5) interface, and the UE (e.g., the UE 111A) would simultaneously transmit/receive on one or more SL carriers and on an UL carrier, if the UE is not capable of simultaneously transmitting/receiving on the SL and transmit on the UL, there is a need to prioritize transmissions/receptions on the SL and transmissions on the UL. Limitations that apply when the UE would simultaneously transmit on the UL and on the SL in a carrier or in two respective carriers, and the UE is not capable of simultaneous transmissions on the UL and on the SL in the carrier or in the two respective carriers, would also apply when the UE is configured with carrier aggregation on multiple carriers for SL. Additionally, the UE may postpone deprioritized transmissions or receptions on UL/DL, on SL, or on both UL and SL. Whether the UE postpones transmissions or receptions may be subject to a configuration, or may depend on whether the transmission/reception is for an UL/DL or SL channel, or on whether the transmission/reception is of a PSFCH or a PSSCH/PSCCH. For example, a UE may postpone PSSCH/PSCCH transmissions/receptions and not postpone PSFCH transmissions/receptions.

For prioritization between SL transmission or PSFCH/SL synchronization signal (S-SS)/PSBCH block reception on carrier c of the multiple SL carriers and UL transmission on an UL carrier f other than a physical random access channel (PRACH), or a PUSCH scheduled by an UL grant in a random access response (RAR) and its retransmission, or a PUSCH corresponding to Type-2 random access procedure and its retransmission, or a PUCCH with sidelink HARQ-ACK information report, if the UL transmission on carrier f is for a PUSCH or for a PUCCH with priority index 1, unless a higher layer parameter, e.g., sl-PriorityThreshold-UL-URLLC is provided, indicates that the SL transmission or reception on carrier c has higher priority than the UL transmission, the UL transmission has higher priority than the SL transmission or reception. If instead the UL transmission, PUSCH or PUCCH, does not have priority index 1, the SL transmission or reception has higher priority than the UL transmission if the priority value of the SL transmission(s) or reception is smaller than a threshold value provided by a higher layer parameter, e.g., sl-PriorityThreshold; otherwise, the UL transmission has higher priority than the SL transmission or reception.

A PRACH transmission, or a PUSCH scheduled by an UL grant in a RAR and its retransmission, or a PUSCH for Type-2 random access procedure and its retransmission, or a PUCCH with HARQ-ACK information in response to successRAR, or a PUCCH indicated by a DCI format 1_0 with CRC scrambled by a corresponding TC-RNTI, on carrier f, has higher priority than a SL transmission or reception on carrier c.

A PUCCH transmission with a sidelink HARQ-ACK information report on carrier f has higher priority than a SL transmission if a priority value of the PUCCH is smaller than a priority value of the SL transmission on carrier c. If the priority value of the PUCCH transmission is larger than the priority value of the SL transmission, the SL transmission has higher priority.

A PUCCH transmission with a sidelink HARQ-ACK information report on carrier f has higher priority than a PSFCH/S-SS/PSBCH block reception on carrier c if a priority value of the PUCCH is smaller than a priority value of the SL reception. If the priority value of the PUCCH transmission is larger than the priority value of the PSFCH/S-SS/PSBCH block reception, the SL reception has higher priority.

When one or more SL transmissions in one or more SL carriers from a UE overlap in time with multiple non-overlapping UL transmissions on an UL carrier f from the UE, the UE performs the SL transmissions in the one or more SL carriers if at least one SL transmission on one carrier c is prioritized over UL transmissions subject to the UE processing timeline with respect to the first SL transmission and the first UL transmission.

When one or more UL transmissions in a carrier f from a UE overlap in time with multiple non-overlapping SL transmissions in one or more SL carriers, the UE performs the UL transmissions if at least one UL transmission is prioritized over SL transmissions subject to the UE processing timeline with respect to the first SL transmission and the first UL transmission.

When one SL transmission in carrier c overlaps in time with one or more overlapping UL transmissions in carrier f the UE performs the SL transmission if the SL transmission is prioritized over UL transmissions subject to both the UE multiplexing and processing timelines with respect to the first SL transmission and the first UL transmission, where the UE processing timeline with respect to the first SL transmission and the first UL transmission is same as when one or more SL transmissions overlap in time with multiple non-overlapping UL transmissions.

When one SL transmission in carrier c overlaps in time with one or more overlapping UL transmissions in carrier f, the UE (e.g., the UE 111A) performs the UL transmission if at least one UL transmission is prioritized over the SL transmission subject to both the UE multiplexing and processing timelines with respect to the first SL transmission and the first UL transmission, where the UE processing timeline with respect to the first SL transmission and the first UL transmission is same as when one or more SL transmissions overlap in time with multiple non-overlapping UL transmissions.

When a UE is configured for operation with carrier aggregation on a first number N of carriers for SL (e.g., PC5) interface and would simultaneously transmit on the first number of carriers, if the UE is capable of simultaneously transmitting on a second number M of carriers, wherein the second number is smaller than the first number, and can be 1 or larger, the UE determines the M SL transmissions on the respective M carriers and the respective M transmission powers based on a priority associated with the N carriers, wherein the transmission power on one or more carriers can be zero (no transmission). The UE can be indicated the priority associated with the N carriers by higher layer signaling (e.g., RRC signaling) or MAC CE signaling, or L1 control (e.g., DCI or SCI) signaling.

For example, an RRC signaling can configure a value M for the number of carriers that can be simultaneously used by the UE for SL transmissions, wherein the value M is subject to a UE capability and can be the same value as, or a smaller value than, the maximum number of carriers that the UE is capable of using for simultaneous transmissions. The RRC signaling may configure each of the N carriers as enabled or disabled for simultaneous SL transmissions.

For example, a MAC CE can indicate a set of carriers from the N configured carriers including M carriers that the UE should prioritize for simultaneous transmissions, or can indicate the carrier that the UE should prioritize for transmission when M is 1. A bitmap of N bits corresponding to the N carriers can indicate the M carriers that the UE should prioritize for simultaneous transmissions, or indicate the carriers with higher priority, if the value is ‘0’ and indicate the carriers that the UE should not prioritize for simultaneous transmissions, or indicate the carriers with lower priority, if the value is ‘1’, or vice versa.

For example, a L1 control signaling can be a 1-bit signaling on each carrier that indicates that the carrier should be prioritized if the value is ‘0’ or that the carrier should not be prioritized if the value is ‘1’, or vice versa.

For example, a 1-bit field in a SCI format can indicate whether the carrier should be prioritized. The 1-bit field in a SCI format may be present for prioritized carriers, and the value of the 1-bit field, for example the value of ‘1’, indicates the carrier with the highest priority among the prioritized carriers, wherein the carrier with the highest priority can be the carrier for which no power reduction is applied when the total UE transmission power for the simultaneous SL transmissions over the respective SL carriers would exceed P_{CMAX}, and/or the carrier to use when the UE transmits with a single carrier.

When a UE is configured for operation with carrier aggregation on a first number N of carriers for SL (e.g., PC5) interface and would simultaneously transmit on the first number of SL carriers and on the UL, if the UE is capable of simultaneously transmitting on a second number M of carriers, wherein M is smaller than (N+1) and can be 1 or larger, the UE determines M SL transmissions on respective M carriers and respective M transmission powers, wherein the transmission power on one or more carriers can be zero (no transmission). The UE can be indicated the priority associated with the N SL carriers and the UL carrier by higher layer signaling (e.g., RRC signaling) and/or MAC CE signaling and/or L1 control (e.g., DCI or SCI) signaling. In one example, an RRC signaling indicates the priority between UL and SL, and a MAC CE signaling or a 1-bit signaling in an SCI format indicates the priority of the SL carriers. In one example, an RRC signaling indicates the priority between UL and SL, a MAC CE signaling or a 1-bit signaling in an DCI format indicates the priority of the UL carrier, and a MAC CE signaling or a 1-bit signaling in an SCI format indicates the priority of the SL carriers.

When a UE is configured for operation with carrier aggregation on N1 carriers for SL (e.g., PC5) interface and with carrier aggregation on N2 carriers for the UL, and would simultaneously transmit on the N1 SL carriers and on the N2 UL carriers, if the UE is capable of simultaneously transmitting on M SL and/or UL carriers, wherein M is smaller than (N1+N2) and can be 1 or larger, the UE determines M transmissions on respective M carriers and respective M transmission powers, wherein the transmission power on one or more carriers can be zero (no transmission). The UE can be indicated the priority associated with the N1 SL carriers and the N2 UL carrier by higher layer signaling (e.g., RRC signaling) and/or MAC CE signaling and/or L1 control (e.g., DCI or SCI) signaling.

When a UE is configured for operation with carrier aggregation on N1 carriers for SL (e.g., PC5) interface and with carrier aggregation on N2 carriers for the UL, and would simultaneously transmit on the N1 SL carriers and on the N2 UL carriers, if the UE is capable of simultaneously transmitting on M1<N1 carriers for SL and on M2<N2 carriers for UL, and M1 and M2 can each be 1 or larger, the UE determines (M1+M2) transmissions on respective (M1+M2) carriers and respective (M1+M2) transmission powers, wherein the transmission power on one or more carriers can be zero (no transmission). The UE can be indicated the priority associated with the N1 SL carriers and the N2 UL carrier by higher layer signaling (e.g., RRC signaling) and/or MAC CE signaling and/or L1 control (e.g., DCI or SCI) signaling.

When a UE is configured for operation with carrier aggregation on N1 carriers for SL (e.g., PC5) interface and with carrier aggregation on N2 carriers for the UL, and would simultaneously transmit and/or receive on the N1 SL carriers and transmit on the N2 UL carriers, if the UE is capable of simultaneously transmitting/receiving on M carriers, wherein M is smaller than (N1+N2) and can be 1 or larger, the UE determines M transmissions/receptions on respective M carriers. The UE can be indicated the priority associated with the N1 SL carriers and the N2 UL carrier by higher layer signaling (e.g., RRC signaling) and/or MAC CE signaling and/or L1 control (e.g., DCI or SCI) signaling.

The above flowchart illustrates an example method that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive first information for sidelink operation on multiple sidelink carriers, wherein the first information includes priority values associated with the multiple sidelink carriers; and
a processor operably coupled to the transceiver, the processor configured to determine:
a first number of sidelink carriers from the multiple sidelink carriers based on the priority values;
first simultaneous transmissions or receptions on the first number of sidelink carriers based on the first information;
a first sidelink carrier from the multiple sidelink carriers, wherein the first sidelink carrier is not in the first number of sidelink carriers; and
whether to postpone or drop a first transmission or reception on the first sidelink carrier based on a physical channel associated with the first transmission or reception;
wherein the transceiver is further configured to transmit or receive the first simultaneous transmissions or receptions on the first number of sidelink carriers.

2. The UE of claim 1, wherein:
the first number is a maximum number associated with UE capability information, and
the UE capability information comprises an indication for at least one of:
simultaneous transmissions,
simultaneous receptions, and
simultaneous transmissions or receptions.

3. The UE of claim 1, wherein:
the first transmission of a physical sidelink feedback channel (PSFCH) in transmission occasion i is postponed to a next available PSFCH transmission occasion on the first sidelink carrier, or
the first transmission of a physical sidelink control channel (PSCCH) or a physical sidelink shared channel (PSSCH) in slot n is postponed to a PSCCH-PSSCH transmission occasion in a subsequent slot n+m, where m is a positive integer.

4. The UE of claim 1, wherein:
the first reception of a physical sidelink shared channel (PSSCH) on the first sidelink carrier is dropped, and
the transceiver is further configured to transmit a request in a sidelink control information (SCI) format for retransmission of the PSSCH on the first sidelink carrier.

5. The UE of claim 1, wherein:
the first reception of a physical sidelink feedback channel (PSFCH) with hybrid automatic repeat request acknowledgement (HARQ-ACK) information corresponding to a physical sidelink shared channel (PSSCH) on the first sidelink carrier is dropped, and
the transceiver is further configured to retransmit the PSSCH on the first sidelink carrier.

6. The UE of claim 1, wherein:
a first priority value from the priority values is associated with a first time interval, and
a second priority value from the priority values is associated with a second time interval.

7. The UE of claim 1, wherein:
the transceiver is further configured to receive second information for an uplink transmission on an uplink carrier;
the processor is further configured to determine second simultaneous transmissions or receptions based on:
a priority index between the uplink carrier and the multiple sidelink carriers, and
the priority values; and
the transceiver is further configured to transmit or receive the second simultaneous transmissions or receptions.

8. The UE of claim 7, wherein:
the priority index is not larger than a smallest priority value; and
the transceiver is further configured to transmit the uplink transmission on the uplink carrier.

9. The UE of claim 7, wherein:
the uplink transmission is a physical uplink control channel (PUCCH), and
the transceiver is further configured to transmit the PUCCH on the uplink carrier.

10. The UE of claim 7, wherein
the second information is for multiple uplink transmissions on multiple uplink carriers,
the priority index is associated with the multiple uplink carriers, and
the second simultaneous transmissions or receptions include the multiple uplink transmissions when the priority index is not larger than a smallest priority value.

11. A method performed by a user equipment (UE) in a wireless communication system, the method comprising:
receiving first information for sidelink operation on multiple sidelink carriers, wherein the first information includes priority values associated with the multiple sidelink carriers;
determining:
a first number of sidelink carriers from the multiple sidelink carriers based on the priority values;
first simultaneous transmissions or receptions on the first number of sidelink carriers based on the first information;
a first sidelink carrier from the multiple sidelink carriers, wherein the first sidelink carrier is not in the first number of sidelink carriers; and
whether to postpone or drop a first transmission or reception on the first sidelink carrier based on a physical channel associated with the first transmission or reception; and
transmitting or receiving the first simultaneous transmissions or receptions on the first number of sidelink carriers.

12. The method of claim 11, wherein:
the first number is a maximum number associated with UE capability information, and
the UE capability information comprises an indication for at least one of:
simultaneous transmissions,
simultaneous receptions, and
simultaneous transmissions or receptions.

13. The method of claim 11, wherein:
the first transmission of a physical sidelink feedback channel (PSFCH) in transmission occasion i is postponed to a next available PSFCH transmission occasion on the first sidelink carrier, or
the first transmission of a physical sidelink control channel (PSCCH) or a physical sidelink shared channel (PSSCH) in slot n is postponed to a PSCCH-PSSCH transmission occasion in a subsequent slot n+m, where m is a positive integer.

14. The method of claim 11, wherein:
the first reception of a physical sidelink shared channel (PSSCH) on the first sidelink carrier is dropped, and
the method further comprises transmitting a request in a sidelink control information (SCI) format for retransmission of the PSSCH on the first sidelink carrier.

15. The method of claim 11, wherein:
the first reception of a physical sidelink feedback channel (PSFCH) with hybrid automatic repeat request acknowledgement (HARQ-ACK) information corresponding to a physical sidelink shared channel (PSSCH) on the first sidelink carrier is dropped, and
the method further comprises retransmitting the PSSCH on the first sidelink carrier.

16. The method of claim 11, wherein:
a first priority value from the priority values is associated with a first time interval, and
a second priority value from the priority values is associated with a second time interval.

17. The method of claim 11, further comprising:
receiving second information for an uplink transmission on an uplink carrier;
determining second simultaneous transmissions or receptions based on:
a priority index between the uplink carrier and the multiple sidelink carriers, and
the priority values; and
transmitting or receiving the second simultaneous transmissions or receptions.

18. The method of claim 17, wherein:
the priority index is not larger than a smallest priority value; and
the method further comprises transmitting the uplink transmission on the uplink carrier.

19. The method of claim 17, wherein:
the uplink transmission is a physical uplink control channel (PUCCH), and
the method further comprises transmitting the PUCCH on the uplink carrier.

20. The method of claim 17, wherein:
the second information is for multiple uplink transmissions on multiple uplink carriers,
the priority index is associated with the multiple uplink carriers, and
the second simultaneous transmissions or receptions include the multiple uplink transmissions when the priority index is not larger than a smallest priority value.
